(19) United States
(12) Patent Application Publication
(10) Pub. No.: US 2004/0075738 A1
(43) Pub. Date: Apr. 22, 2004

(54) Spherical surveillance system architecture

(76) Inventors: Sean Burke, Portland, OR (US); Mark Denies, Lake Oswego, OR (US); Gwendolyn Hunt, Portland, OR (US); Mark Lam, Beaverton, OR (US); Michael C. Park, Portland, OR (US); G. David Ripley, Portland, OR (US)

Correspondence Address: FENWICK & WEST LLP, SILICON VALLEY CENTER, 801 CALIFORNIA STREET, MOUNTAIN VIEW, CA, 94041, US

(21) Appl. No.: 10/647,098

(22) Filed: Aug. 22, 2003

Related U.S. Application Data
(63) Continuation-in-part of application No. 10/228,541, filed on Aug. 27, 2002, now Pat. No. 6,690,374.
Application No. 10/228,541 is a continuation-in-part of application No. 10/003,399, filed on Oct. 22, 2001, now Pat. No. 6,654,019.
Application No. 10/003,399 is a continuation of application No. 09/310,715, filed on May 12, 1999, now Pat. No. 6,337,683.
Application No. 10/228,541 is a continuation-in-part of application No. 10/136,659, filed on Apr. 30, 2002.
Application No. 10/136,659 is a continuation-in-part of application No. 09/992,090, filed on Nov. 16, 2001, now abandoned.
Application No. 10/136,659 is a continuation-in-part of application No. 09/994,081, filed on Nov. 23, 2001, now abandoned.

(51) Int. Cl. H04N 7/18; H04N 9/47

(52) U.S. Cl. 348/143; 348/153

(57) ABSTRACT

Spherical surveillance system architecture delivers real time, high-resolution spherical imagery integrated with surveillance data (e.g., motion detection event data) to one or more subscribers (e.g., consoles, databases) via a network (e.g., copper or wireless). One or more sensors are connected to the network to provide the spherical images and surveillance data in real time. In one embodiment, the spherical images are integrated with surveillance data (e.g., data associated with motion detection, object tracking, alarm events) and presented on one or more display devices according to a specified display format. In one embodiment, raw spherical imagery is analyzed for motion detection and compressed at the sensor before it is delivered to subscribers over the network, where it is decompressed prior to display. In one embodiment, the spherical imagery integrated with the surveillance data is time stamped and recorded in one or more databases for immediate playback on a display device in reverse or forward directions.

### CROSS-RELATED APPLICATIONS

This application is a continuation-in-part of U.S. patent application Ser. No. 10/228,541, filed Aug. 27, 2002, which is a continuation-in-part of U.S. patent application No. 10/003,399, filed Oct. 22, 2001, which is a continuation of U.S. patent application Ser. No. 09/310,715, filed May 12, 1999, now U.S. Pat. No. 6,337,683, each of which are incorporated herein by reference.

This application is a continuation-in-part of U.S. patent application Ser. No. 10/228,541, filed Aug. 27, 2002, which is a continuation-in-part of U.S. patent application Ser. No. 10/136,659, filed Apr. 30, 2002, which is continuation-in-part of U.S. patent application Ser. Nos. 09/992,090, filed Nov. 16, 2001, and 09/994,081, filed Nov. 23, 2001, each of which are incorporated herein by reference.

### FIELD OF THE INVENTION

The invention relates generally to video-based security and surveillance systems and methods and, more particularly, to a surveillance system architecture for integrating real time spherical imagery with surveillance data.

### BACKGROUND OF THE INVENTION

Spherical video is a form of immersive panoramic media that provides users with 360° views of an environment in the horizontal direction and up to 180° views of an environment in the vertical direction, referred to as a spherical view. Users can navigate through a spherical video looking at any point and in any direction in the spherical view. One example of a spherical video system is the SVS-2500 manufactured by iMove, Inc. (Portland, Oreg.). The SVS-2500 includes a specialized 6-lens digital camera, portable capture computer and post-production system. Designed for field applications, the camera is connected to a portable computer system and includes a belt battery pack and a removable disk storage that can hold up to two hours of content. During post-production, the images are seamed and compressed into panoramic video frames, which offer the user full navigational control.

Spherical video can be used in a variety of applications. For example, spherical video can be used by public safety organizations to respond to emergency events. Law enforcement personnel or firefighters can use spherical video to virtually walk through a space before physically entering, thereby enhancing their ability to respond quickly and effectively. Spherical video can also document space in new and comprehensive ways. For example, a spherical video created by walking through a museum, church, or other public building can become a visual record for use by insurance companies and risk planners. In forensic and criminal trial settings, a spherical video, created before any other investigative activity takes place, may provide the definitive answer to questions about evidence contamination. Spherical video also provides a way for investigators and jurors to understand a scene without unnecessary travel.

One of the most promising uses for spherical video is in security applications. Conventional surveillance systems force operators to view and track objects moving through an environment using multiple single view cameras. Such conventional systems typically result in blind spots and often require the operator to view multiple display screens simultaneously and continuously. These problems are compounded when conventional systems are used for real time monitoring of an environment over a long period of time and for reporting Incidents to multiple operators at local and remote locations.

By contrast, spherical video virtually eliminates blind spots and provides the operator with a spherical view of the environment on a single display device. Objects can be tracked within the environment without losing the overall context of the environment. With a single control, the operator can pan or tilt anywhere in the spherical view and zoom in on specific objects of interest without having to manipulate multiple single view cameras.

Recognizing the benefits of spherical video, businesses and governments are requesting that spherical video be integrated with existing security solutions. Preferably, such an integrated system will integrate spherical imagery with traditional surveillance data, including data associated with motion detection, object tracking and alarm events from spherical or other types of security or surveillance sensors. It is further desired that such an integrated system be modular and extensible in design to facilitate its adaptability to new security threats or environments.

Accordingly, there is a need for a modular and extensible comprehensive security solution that can capture, distribute and display real time spherical video integrated with surveillance data, such as data associated with motion detection, object tracking and alarm events.

### SUMMARY OF THE INVENTION

The present invention overcomes the deficiencies in the prior art by providing a modular and extensible spherical video surveillance system architecture that can capture, distribute and display real time spherical video integrated with surveillance data. The spherical surveillance system architecture delivers real time, high-resolution spherical imagery integrated with surveillance data (e.g., motion detection event data) to one or more subscribers (e.g., consoles, databases) via a network (e.g., copper, optical fiber, or wireless). One or more sensors are connected to the network to provide the spherical images and surveillance data in real time. In one embodiment, the spherical images are integrated with surveillance data (e.g., data associated with motion detection, object tracking, alarm events) and presented on one or more display devices according to a specified display format. In one embodiment, raw spherical imagery is analyzed for motion detection and compressed at the sensor before it is delivered to subscribers over the network, where it is decompressed prior to display. In one embodiment, the spherical imagery integrated with the surveillance data is time stamped and recorded in one or more databases for immediate or later playback on a display device in reverse or forward directions.

### BRIEF DESCRIPTION OF THE DRAWINGS

FIG. 1 is a block diagram of a spherical video surveillance system, in accordance with one embodiment of the present invention.

FIG. 2 is a block diagram of a Sensor Management Console (SMC), in accordance with one embodiment of the present invention.

FIG. 3A is a block diagram of the Sensor System Unit (SSU), in accordance with one embodiment of the present invention.

FIG. 3B is a block diagram of a distributed form of SSU, in accordance with one embodiment of the present invention.

FIG. 4 is a block diagram of a Data Repository, in accordance with one embodiment of the present invention.

FIG. 5 is a block diagram illustrating the components of System Services, in accordance with one embodiment of the present invention.

FIG. 6 is a diagram illustrating a class hierarchy of data source services, in accordance with one embodiment of the present invention.

FIG. 7 is a block diagram illustrating four layers in a motion detection protocol, in accordance with one embodiment of the present invention.

FIG. 8 is a block diagram illustrating a motion detection process, in accordance with one embodiment of the present invention.

FIG. 9 is a block diagram of a motion detection subsystem for implementing the process shown in FIG. 8, in accordance with one embodiment of the present invention.

FIG. 10 is diagram illustrating a class hierarchy of the motion detection subsystem show in FIG. 9, in accordance with one embodiment of the present invention.

FIG. 11 is a diagram illustrating data flow in the motion detection subsystem shown in FIG. 9, in accordance with one embodiment of the present invention.

FIG. 12 is a screen shot of a Launch Display (LD) in accordance with one embodiment of the present invention.

FIG. 13 is a screen shot of a Management Display (MD), in accordance with one embodiment of the present invention.

FIG. 14 is a screen shot of a Sensor Display (SD), in accordance with one embodiment of the present invention.

FIG. 15 is a screen shot of an Administrative Display (AD), in accordance with one embodiment of the present invention.

### DETAILED DESCRIPTION OF THE PREFERRED EMBODIMENTS

### Architecture Overview

While the description that follows pertains to a particular surveillance system architecture, the present invention provides a scalable architecture that can be readily configured to handle a variety of surveillance environments and system requirements, including but not limited to requirements related to power, bandwidth, data storage and the like.

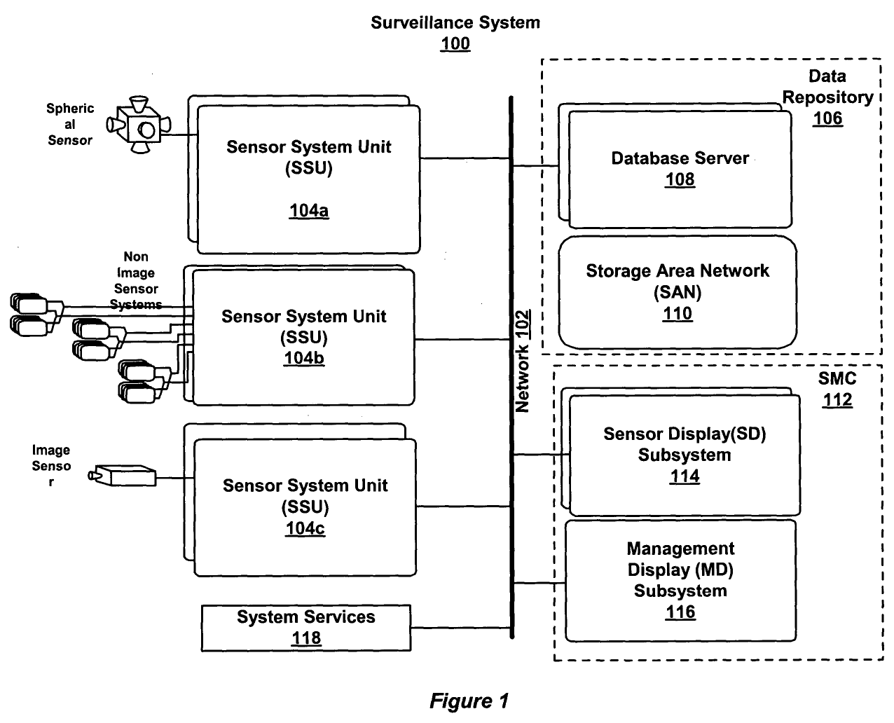

FIG. 1 is a block diagram of a spherical video surveillance system 100, in accordance with one embodiment of the present invention. The system 100 includes a network 102 operatively coupled to one or more Sensor Service Units (SSUs) of types 104a, 104b and 104c or combinations of (SSUs), a Data Repository 106, a Sensor Management Console (SMC) 112, and System Services 118. The Data Repository 106 further includes a Database Server 108 and a centralized files system and disk array built on a Storage Area Network (SAN) 110. The SMC 112 further includes a Sensor Display (SD) subsystem 114 and a Management Display (MD) subsystem 116. Additional numbers and types of sensors can be added to the system 100 by simply adding additional SSU(s). Likewise, additional numbers and types of display devices can be added to the SMC 112 depending on the requirements of the system 100.

In one embodiment of the present invention, one or more SSU 104a are operatively coupled to a spherical image sensor. In another embodiment, one or more SSU 104b are operatively coupled to non-image sensor systems (e.g., radar, microwave perimeter alarm, or vibration detector perimeter alarm). In another embodiment, one or more SSU 104c are operatively coupled to non-spherical image sensor systems (e.g. analog or digital closed circuit television (CCTV) or infrared sensors). The spherical image sensor captures a spherical field of view of video data, which is transmitted over the network 102 by the SSU 104a. The SSU 104a can also detect motion in this field of view and broadcast or otherwise transmit motion detection events to subscribers over the network 102. This allows the SSU 104a to act as a source of alarm events for the system 100.

In one embodiment, the spherical image sensor comprises six camera lenses mounted on a cube. Four of the six lenses are wide-angle lenses and are evenly spaced around the sides of the cube. A fifth wide-angle lens looks out of the top of the cube. The fields of view of these five lenses overlap their neighbors, and together provide a spherical view. The sixth lens is a telephoto lens that looks out of the bottom of the cube and into a mirror mounted on a pan/tilt/zoom controller device, which can be positioned to reflect imagery into the telephoto lens. The telephoto lens provides a source of high-resolution imagery that may be overlaid into a spherical view. The pan/tilt/zoom controller device enables the operator to direct the bottom lens to a particular location in the spherical view to provide a high-resolution image. Hereinafter, such a device is also referred to as a Multiple Resolution Spherical Sensor (MRSS). MRSS devices are described more fully in U.S. application Ser. No. 09/994,081, filed Nov. 16, 2001, which is incorporated by reference herein. The system 100 supports deployment of a mixture of spherical sensors and MRSS devices.

The present invention is applicable to a variety of spherical image sensors having a variety of multi-lens configurations. These spherical image sensors include sensors that together capture spherical image data comprising spherical views.

The Data Repository 106 provides data capture and playback services. Additionally, it supports system data logging, system configuration and automatic data archiving.

The SMC 112 provides user interfaces for controlling the surveillance system 100. The SMC 112 displays spherical video, motion detection events, alarm events, sensor attitude data and general system status information to the system operator in an integrated display format. In one embodiment, the surveillance operator is presented with spherical video data on a SD and situational awareness data on a MD. The SMC 112 allows the surveillance operator to choose which SSU(s) to view, to choose particular fields of views within those SSU(s), to manually control the SSU(s) and to control the motion detection settings of the SSU(s).

The system 100 also includes non-image sensor systems. (e.g., radar) and non-spherical image sensors systems (e.g., CCTV systems). These sensors can be added via additional SSU(s). Data from such devices is delivered to the network 102 where it is made available to one or more subscribers (e.g., SMC 112, Data Repository Image Database 106).

### Multimedia Network

A core function of the surveillance system 100 is the transmission of spherical video data streams and surveillance data across a high bandwidth network in real time for analysis and capture for immediate or later playback by various devices on the network. The data source being displayed or played back changes dynamically in response to user action or alarm events. In one embodiment, the network 102 is a Gigabit Ethernet with IP multicasting capability. The topology of network 102 can be point-to-point, mesh, star, or any other known topology. The medium of network 102 can be either physical (e.g., copper, optical fiber) or wireless.

### Client/Server System

In one embodiment of the present invention, the surveillance system 100 is implemented as a three-tiered client/server architecture, where system configuration, Incident logging, and maintenance activities are implemented using standard client/server applications. Thin client side applications provide user interfaces, a set of server side software objects provide business logic, and a set of database software objects provide data access and persistent storage against a database engine (e.g., Informix SE RDBMS). The business logic objects include authorization rules, system configuration rules, event logging rules, maintenance activities, and any other system level logic required by the system 100.

### Distributed System

The surveillance system 100 is preferably implemented as a loosely coupled distributed system. It comprises multiple network nodes (e.g., a computer or a cluster of computers) with different responsibilities communicating over a network (e.g., Gigabit Ethernet). The present invention uses industry standard technologies to implement a reliable distributed system architecture including distributed database systems, data base replication services, and distributed system middleware technologies, such as Common Object Request Broker Architecture (CORBA), Distributed Component Object Model (DCOM), and Java Messaging Services. Preferably, system configuration information will be replicated among multiple databases. A network node may include a single computer, a loosely coupled collection of computers, or a tightly coupled cluster of computers (e.g., implemented via commercially available clustering technologies).

The distributed system middleware technology is applied between network nodes and on a single network node. This makes the network node location of a service transparent under most circumstances. In one embodiment, the system 100 will use CORBA (e.g., open source TAO ORB) as the distributed system middleware technology.

### Event Driven System

The system 100 is preferably an event driven system. Objects interested in events (e.g., CORBA Events) register with the event sources and respond appropriately, handling them directly or generating additional events to be handled as needed. Events are used to communicate asynchronous changes in system status. These include system configuration changes (e.g., motion detection and guard zones added, deleted, activated, deactivated, suspended, etc.), motion detection events, alarm events, and hardware status change events (e.g., sensor power on/off).

### Sensor Management Console (SMC) Subsystems

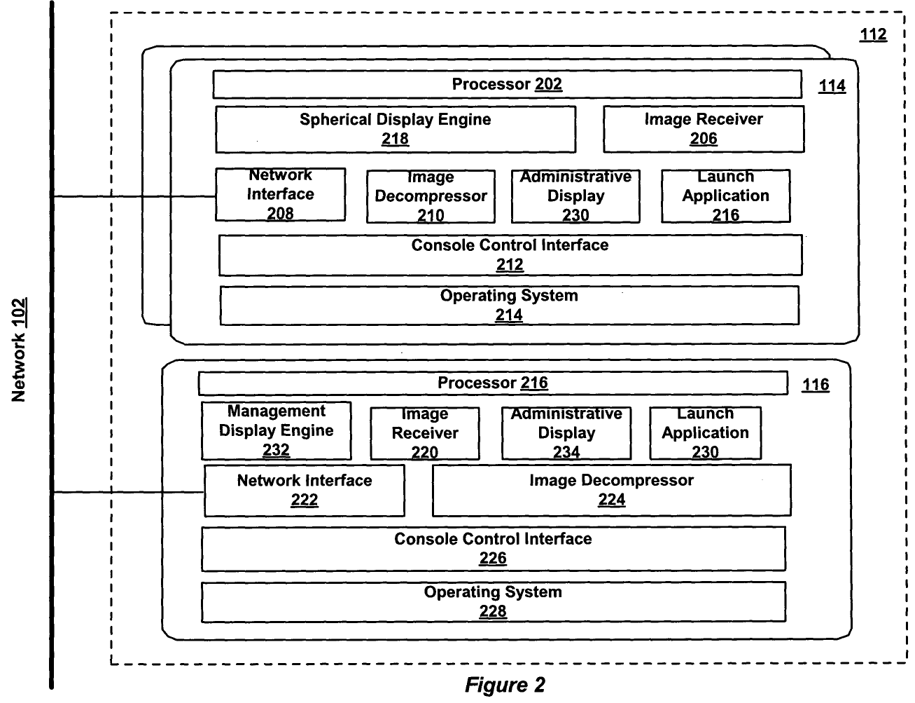

FIG. 2 is a block diagram of the SMC 112, in accordance with one embodiment of the present invention. The SMC 112 includes two of the SD subsystems 114 and one of the MD subsystem 116. Each of these subsystems is described below. In one embodiment, the SMC 112 is built using three IBM Intellistation Z workstations using OpenGL hardware accelerated video graphics adapters. Two of the three workstations are set up to display spherical imagery (e.g., low and high resolution) and have control devices (e.g., trackballs) to manage operation and image display manipulation while the third workstation is set up to display situation awareness information of the whole system and the environment under surveillance.

### Sensor Display (SD) Components

The SD subsystem 114 is primarily responsible for rendering spherical imagery combined with system status information relevant to the currently displayed sensor (e.g., the mirror position information, guard zone regions, alarm status, and motion detection events). It includes various hardware and software components, including a processor 202, an image receiver 206, a network interface 208, an image decompressor 210, a CORBA interface called the console control interface (CCI) 212, which in one embodiment includes CORBA event channel receivers, an operating system 214, a launch display 216, and a spherical display engine 218. The software components for the SD 114 are stored in memory as instructions to be executed by processor 202 in conjunction with operating system 214 (e.g., Linux 2.4x). In one embodiment an optional software application called the administrative display 230 can be executed on the SD subsystem 114 and started through the launch application 216. In another embodiment the sensor display can also display non-spherical imagery in systems that include non-spherical sensors.

The processor 202 (e.g., IBM Intellistation Z 2-way XEON 2.8 GHz) monitors the system 100 for spherical imagery. The image receiver 206 receives time-indexed spherical imagery and motion detection event data from the network 102 via the network interface 208 (e.g., 1000SX Ethernet). The image receiver 206 manages the video broadcast protocol for the SD 114. If the spherical video data is compressed, then the image decompressor 210 (e.g., hardware assisted JPEG decoding unit) decompresses the data. The decompressed data is then delivered to the spherical display engine 218 for display to the surveillance system operator via the CCI 212, which provides user interfaces for surveillance system operators. The CCI 214 includes handling of hardware and software controls, assignment of spherical video and MD displays to physical display devices, operator login/logoff, operator event logging, and providing access to a maintenance user interface, access to system configuration services, maintenance logs, troubles shooting and system test tasks.

### Management Display (MD) Components

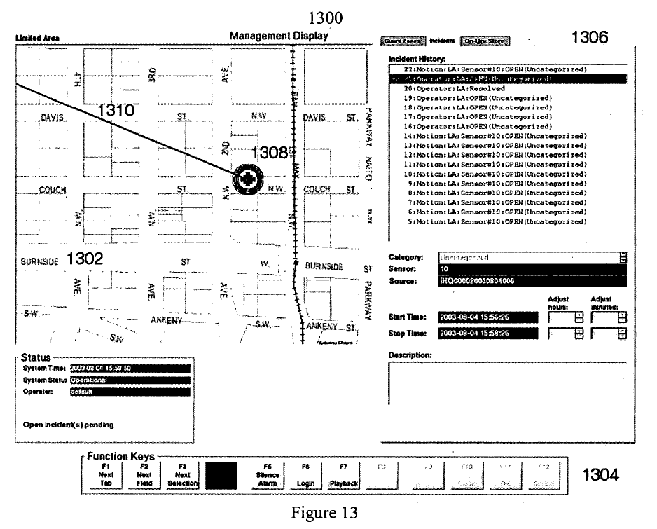

The MD subsystem 116 is primarily responsible for rendering a sensor system map and controls console, as more fully described with respect to FIG. 13. It includes various hardware and software components, including a processor 216, an image receiver 220, a network interface 222, an image decompressor 224, a console control interface (CCI) 226, an operating system 228, a launch display 230, and a MD engine 232. The software components for the MD subsystem 116 are stored in memory as instructions to be executed by processor 216 in conjunction with operating system 228 (e.g., Linux 2.4x). In one embodiment, an optional software application called the administrative display 234 can be executed on the MD subsystem 116 and started through the launch application 230.

The processor 216 (e.g., IBM Intellistation Z 2-way XEON 2.8 GHz) monitors the system 100 for status and alarm events and converts those events into a run time model of the current system status. This includes data related to camera telemetry (e.g., MRSS mirror position data, gain, etc.), operator activity (e.g., current sensor election) and alarm data. It also provides the summary status of the system 100 as a whole. The other components of the MD subsystem 116 operate in a similar way as the corresponding components of the SD subsystem 114, except that the MD subsystem 116 includes MD engine 232 for integrating geo-spatial data with spherical data and real time status data or events, and displays the integrated data in a common user interface. FIG. 13 illustrates one embodiment of such a user interface.

As shown in FIG. 2, the SD subsystem 114 and the MD subsystem 116 each include a dedicated network interface, processor, operating system, decompressor, display engine and control interface. Alternatively, one or more of these elements (e.g., processor, network interface, operating system, etc.) is shared by the SD subsystem 114 and MD subsystem 116.

### Sensor Service Unit (SSU) Components

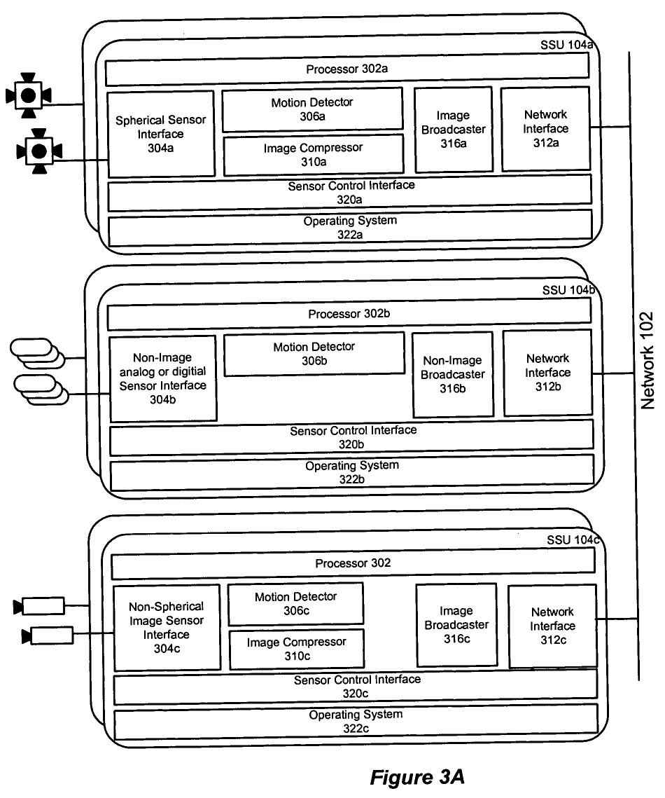

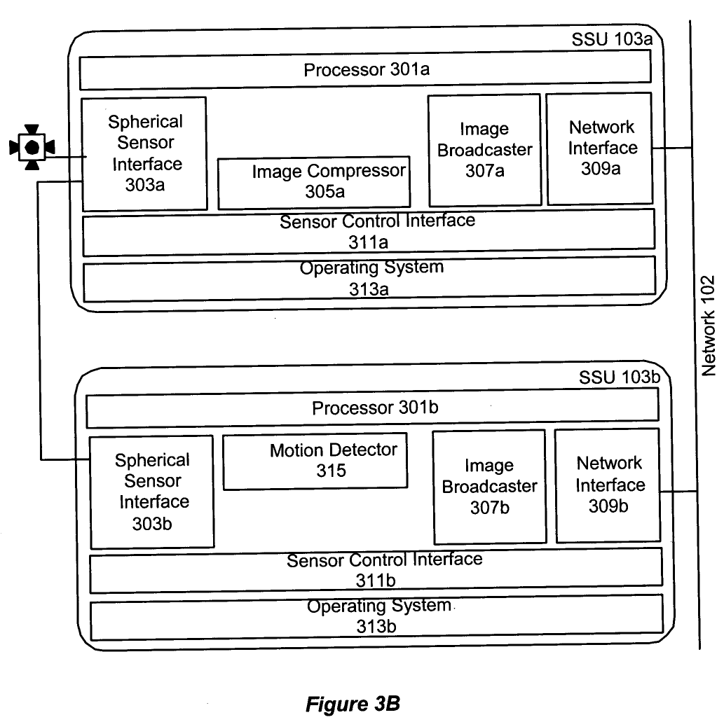

In FIG. 3A, there are three types of Sensor Service Units shown: SSU 104a, SSU 104b and SSU 104c. The SSU 104a, in accordance with one embodiment of the present invention, is an interface to spherical image systems. The SSU 104b, in accordance with one embodiment of the present invention, is an interface to non-image surveillance sensor systems. The SSU 104c, in accordance with one embodiment of the. present invention, is an interface to non-spherical image systems. In one embodiment, the system 100 includes a single SSU 104a. Other embodiments of the system 100 can include combinations of one or more of each of the three types of SSUs. In one embodiment, any of the three types SSUs can have their non-image or image processing distributed across several processing units for higher resolution motion detection and load balancing.

### Sensor Service Unit SSU 104a for Spherical Imagery

The SSU 104a is primarily responsible for generating multicasted, time-indexed imagery and motion detection event data. The SSU 104a includes various hardware and software components, including a processor 302a, a sensor interface 304a, a motion detector 306a, an image compressor 31a, a network interface 312a, an image broadcaster 316a, a sensor control interface 320a, and an operating system 322a. The software components for the SSU 104a are stored in memory as instructions to be executed by the processor 302a in conjunction with the operating system 322a (e.g., Linux 2.4x).

The processor 302a (e.g., IBM Intellistation Z Pro 2-way XEON 2.8 GHz) includes a camera controller for actively maintaining a connection to the spherical sensor. It is responsible for maintaining a heartbeat message that tells the spherical sensor that it is still connected. It also monitors the spherical sensor status and provides an up to date model of the spherical sensor. If the system 100 includes an MRSS, then the processor 302a can also implement IRIS control on a high-resolution camera lens.

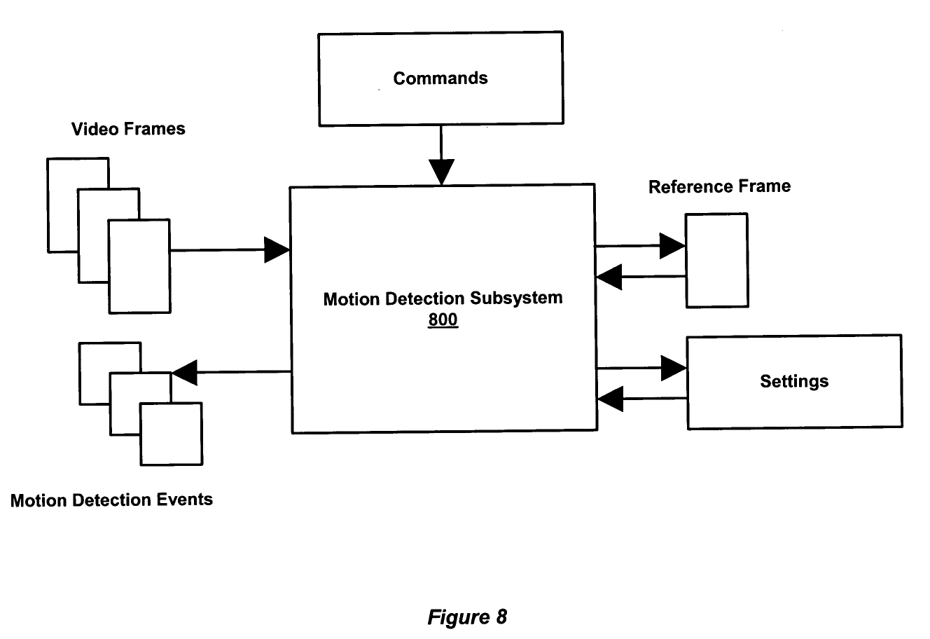

Spherical imagery captured by the spherical sensor is delivered via fiber optic cable to the sensor interface 304a. The spherical imagery received by the sensor interface 304a is then processed by the motion detector 306a, which implements motion detection and cross lens/CCD motion tracking algorithms, as described with respect to FIGS. 8-11. Spherical imagery and motion detection data is compressed by the image compressor 310a (e.g., hardware assisted JPEG encoding unit) and delivered to the network 102 via the image broadcaster 316a.

The sensor control interface 320a provides an external camera control interface to the system 100. It is preferably implemented using distributed system middleware (e.g., CORBA), camera drivers, video broadcasting components and motion detection components. It provides both incoming (e.g., imperative commands and status queries) and outgoing (e.g., status events) communications to the spherical sensor.

### Sensor Service Unit (SSU) 104b for Non-Image Sensors

The SSU 104b is primarily responsible for generating multicasted, time-indexed Non-Image event data. The SSU 104b includes various hardware and software components, including a processor 302b, a sensor interface 304b, a motion detector 306b, a network interface 312b, an non-image broadcaster 316b, a sensor control interface 320b, and an operating system 322b. The software components for the SSU 104b are stored in memory as instructions to be executed by the processor 302b in conjunction with the operating system 322b (e.g., Linux 2.4x). Other types of non-image sensors that can be connected and monitored by SSU 104b include, but are not limited to, ground surveillance radar, air surveillance radar, infrared and laser perimeter sensors, magnetic field disturbance sensors, fence movement alarm sensors, sonar, sonic detection systems and seismic sensors.

The processor 302b (e.g., IBM Intellistation Z Pro 2-way XEON 2.8 GHz) includes a sensor controller for actively maintaining a connection to the non-image sensors. It is responsible for maintaining a heartbeat message that tells whether the sensors are still connected. It also monitors the non-image sensor status and provides an up-to-date model of the sensor

### Sensor Service Unit (SSU) 104c for Non-Spherical Image Sensors

The SSU 104c is primarily responsible for generating multicasted, time-indexed imagery and motion detection event data. The SSU 104c includes various hardware and software components, including a processor 302c, a sensor interface 304c, a motion detector 306c, an image compressor 310c, a network interface 312c, an image broadcaster 316c, a sensor control interface 320c and an operating system 322c. The software components for the SSU 104c are stored in memory as instructions to be executed by the processor 302c in conjunction with the operating system 322c (e.g., Linux 2.4x). The non-spherical imagery that is processed by SSU 104c includes imagery types such as infrared, analog closed circuit and digital closed circuit television, and computer-generated imagery.

The processor 302c (e.g., IBM Intellistation Z Pro 2-way XEON 2.8 GHz) includes a camera controller for actively maintaining a connection to the non-spherical sensor. It is responsible for maintaining a heartbeat message that tells the non-spherical sensor that it is still connected. It also monitors the spherical sensor status and provides an up to date model of the sensor.

Non-Spherical imagery captured by the sensor is delivered via fiber optic cable or copper cable to the sensor interface 304c. The non-spherical imagery received by the sensor interface 304c is then processed by the motion detector 306c, which implements motion detection and motion tracking algorithms, as described with respect to FIGS. 8-11. Non-spherical imagery and motion detection data is compressed by the image compressor 310c (e.g., hardware assisted JPEG encoding unit) and delivered to the network 102 via the image broadcaster 316c.

The sensor control interface 320c provides an external camera control interface to the system 100. It is preferably implemented using distributed system middleware (e.g., CORBA), camera drivers, video broadcasting components and motion detection components. It provides both incoming (e.g., imperative commands and status queries) and outgoing (e.g., status events) communications to the spherical sensor.

FIG. 3B is a block diagram of a distributed form of SSUs where image compressing and broadcasting is handled by one SSU 103a, while motion detection event data is handled by SSU 103b. In this one embodiment, more processing resources can be dedicated to the image compression and to the motion detection functions of the SSU.

### Sensor Service Unit 103a

The SSU 103a includes various hardware and software components, including a processor 301a, a spherical sensor interface 303a, an image broadcaster 307a, an image compressor 305a, a network interface 309a, a sensor control interface 311a and an operating system 313a. The software components for the SSU 103a are stored in memory as instructions to be executed by the processor 301a in conjunction with the operating system 313a (e.g., Linux 2.4x).

The processor 301a (e.g., IBM Intellistation Z Pro 2-way XEON 2.8 GHz) includes a camera controller for actively maintaining a connection to the spherical sensor. It is responsible for maintaining a heartbeat message that tells the spherical sensor that it is still connected. It also monitors the spherical sensor status and provides an up to date model of the spherical sensor. If the system 100 includes an MRSS, then the processor 301a can also implement IRIS control on a high-resolution camera lens.

Spherical imagery captured by the spherical sensor is delivered via fiber optic cable to the sensor interface 303a. The spherical imagery received by the sensor interface 303a is then compressed by the image compressor 305a (e.g., hardware assisted JPEG encoding unit) and delivered to the network 102 via the image broadcaster 307a. A parallel stream of the spherical image data is simultaneously delivered to SSU 103b via fiber optic cable coupled to the spherical sensor interface 303b.

The sensor control interface 303a provides an external camera control interface to the system 100. It is preferably implemented using distributed system middleware (e.g., CORBA), camera drivers and video broadcasting components. It provides both incoming (e.g., imperative commands and status queries) and outgoing (e.g., status events) communications to the spherical sensor.

### Sensor Service Unit 103b

The SSU 103b includes various hardware and software components, including a processor 301b, a spherical sensor interface 303b, a motion detector 315, an image broadcaster 307b, a network interface 309b, a sensor control interface 311b and an operating system 313b. The software components for the SSU 103b are stored in memory as instructions to be executed by the processor 301b in conjunction with the operating system 313b (e.g., Linux 2.4x).

The processor 301b (e.g., IBM Intellistation Z Pro 2-way XEON 2.8 GHz) includes a camera controller for actively maintaining a connection to the spherical sensor.

Spherical imagery captured by the spherical sensor is delivered via fiber optic cable to SSU 103a via the sensor interface 303a and simultaneously delivered to SSU 103b via the sensor interface 303b.

The spherical imagery received by the sensor interface 303b is then processed by the motion detector 315, which implements motion detection and cross lens/CCD motion tracking algorithms, as described with respect to FIGS. 8-11. Motion detection data is delivered to the network 102 via the image broadcaster 307b via network interface 309b.

The sensor control interface 311b provides an external camera control interface to the system 100. It is preferably implemented using distributed system middleware (e.g., CORBA), motion detection components. It provides both incoming (e.g., imperative commands and status queries) and outgoing (e.g., status events) communications to the motion detection subsystems.

### Data Repository

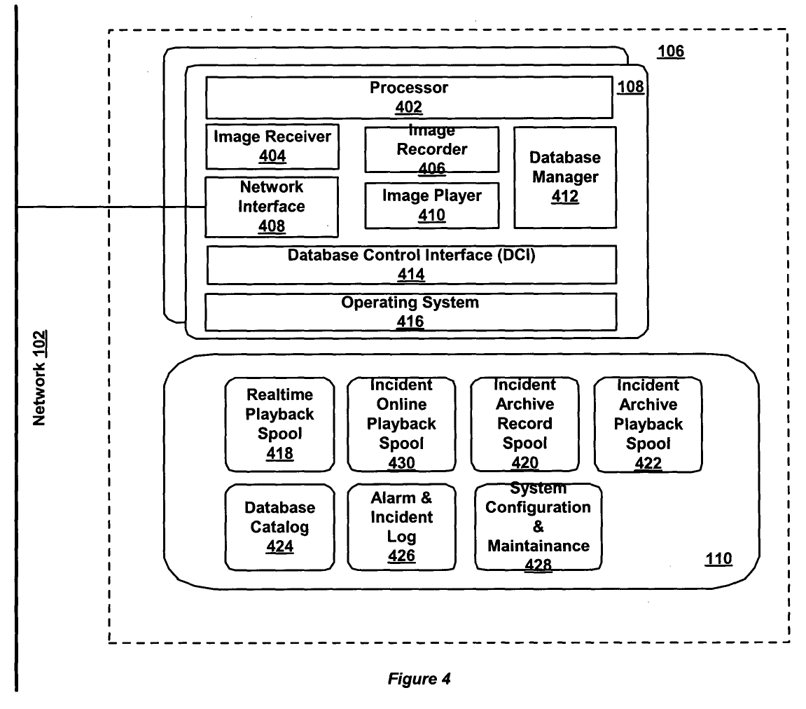

FIG. 4 is a block diagram of the Data Repository 106, in accordance with one embodiment of the present invention. The Data Repository 106 includes one or more Database Servers 108 and the SAN 110. Each of these subsystems is described below.

### Database Servers

The Database Server 108 is primarily responsible for the recording and playback of imagery on demand in forward or reverse directions. It includes various hardware and software components, including processor 402, image receiver 404, image recorder 406, network interface 408, image player 410, database manager 412, database control interface (DCI) 414 and operating system 416. The software components for the Data Repository 106 are stored in memory as instructions to be executed by the processor 402 in conjunction with the operating system 416 (e.g., Linux 2.4x). In one embodiment, the Data Repository 106 includes two Database Servers 108, which work together as a coordinated pair.

The processor 402 (e.g., IBM x345 2-way XEON 2.4 GHz) for each Database Server 108 monitors the system 100 for imagery. It is operatively coupled to the network 102 via the network interface 408 (e.g., 1000× Ethernet).

The image recorder 406 and the image player 410 are responsible for recording and playback, respectively, of video data on demand. These components work in conjunction with the database manager 412 and the DCI 414 to read and write image data to and from the SAN 110. In one embodiment, the image recorder 406 and the image player 410 are on separate database servers for load balancing, each having an internal RAID 5 disk array comprising six, 73 GB UltraSCSI 160 hard drives. The disk arrays are used with Incident Archive Record Spool 420 and the Incident Archive Playback Spool 422.

### Storage Area Network (SAN) Components

In one embodiment, the SAN 110 can be a IBM FAStT 600 dual RAID controller with 2 GB fibre channel fabric with a disk array expansion unit (IBM EXP 700), and with a disk array configured for raw capacity of 4.1 TB data across 26 each, 146 GB fibre channel hard drives with two online spares. This physical disk array is formatted as 4 each, 850 GB RAID 5 logical arrays and are used to store all image and non-image data. The SAN 110 logical arrays are mounted by the Database Servers 108 as physical partitions through a pair of Qlogic 2200 fibre channel host adapters connected to the SAN 110 fabric. The SAN 110 fabric can include a pair of IBM 3534F08 fibre channel switches configured in a failover load balancing tandem.

### Image Database

The Data Repository 106 can be abstracted to support multiple physical database types applied to multiple sources of time synchronous data. For example, the Data Repository 106 can be abstracted into an off-line tape repository (for providing long-term commercial grade database backed video data), a file based repository (for providing a wrapper class for simple file captures of spherical imagery) and a simulated repository (for acting as a read-only source of video data for testing purposes). This abstraction can be realized using shared file systems provided by SAN 110. In one embodiment, the data stored on SAN 110 includes a Realtime Playback Spool 418, an Incident Online Playback Spool 430, an Incident Archive Record Spool 420, an Incident Archive Playback Spool 422, a Database Catalog 424, an Alarm & Incident Log 426 and a System Configuration and Maintenance Component 428. In one embodiment, the data elements are published via a set of CORBA services, including but not limited to Configuration Services 512, Authorization Services 506, Playback Services 508, and Archive Services 516.

The Realtime Playback Spool 418 has two components: an image store based on a pre-allocated first-in-first-out (FIFO) transient store on a sharable file system (more than one server can access at the same time), and a non-image store comprising a relational database management system (RDBMS). If the stores have a finite limit or duration for storing images, the oldest image can be overwritten once the store has filled. Video images and binary motion and alarm events are stored in the image store with indexing metadata stored in the non-image RDBMS. Additionally, configuration and authorization metadata is stored in the RDBMS. The RDBMS can also be assigned to a sharable file system for concurrent access by multiple database servers.

The Incident Online Playback Spool 430 is a long-term store for selected Incidents. The operator selects image data and event data by time to be copied from the Realtime Playback Spool 418 to the Incident Online Playback Spool 430. This spool can be controlled by the MD subsystem 116.

The Incident Archive Record Spool 420 is used to queue image and non-image data that is scheduled to be exported to tape. This spool can be controlled by the MD subsystem 116.

The Incident Archive Playback Spool 422 is used as a temporary playback repository of image and non-image data that has been recorded to tape.

Both the Realtime Playback Spool 418 and the Incident Online Playback Spool 430 are assigned to partitions on the SAN 110. The Incident Archive Record Spool 420 and Incident Archive Playback Spool 422 are assigned to local disk arrays of the Database Servers 108.

The Database Catalog 424 is a data structure for storing imagery and Incident data.

The Alarm & Incident Log 426 provides continuous logging of operator activity and Incidents. It also provides alarm Incident playback and analysis (i.e., write often, read low). The Alarm & Incident Log 426 can be broken down into the following three categories: (1) system status log (nodes power up/down, hardware installed and removed, etc.), (2) system configuration log (all system configuration changes), (3) Incident log (operator and/or automatically defined “Incidents”, including start and stop time of an Incident, plus any site defined Incident report), (4) operator log (operator log on/off, operator activities, etc.), and (5) logistics and maintenance log (logs all system maintenance actives, including hardware installation and removal, regularly scheduled maintenance activities, parts inventories, etc.).

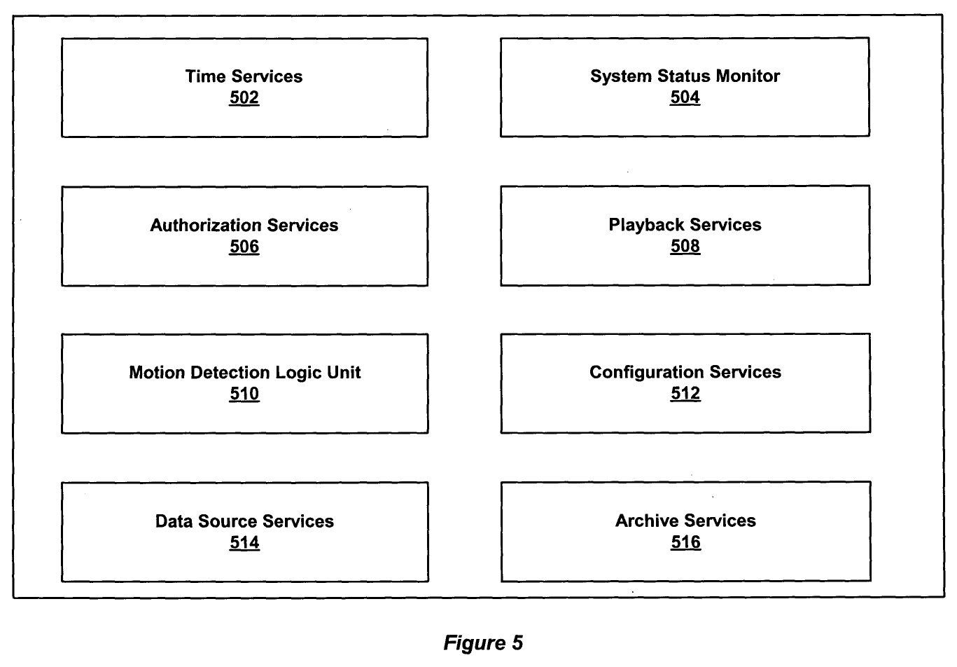

The System Configuration & Maintenance 428 is a data store for the component Configuration Services 512, which is described with respect to FIG. 5. Some examples of system configuration data include but are not limited to: hardware network nodes, logical network nodes and the mapping to their hardware locations, users and groups, user, group, and hardware node access rights, surveillance group definitions and defined streaming data channels.

### System Services

FIG. 5 is a block diagram illustrating the components of the System Services 118 subsystem of the surveillance system 100, in accordance with one embodiment of the present invention. The System Services 118 includes Time Services 502, System Status Monitor 504, Authorization Services 506, Playback Services 508, Motion Detection Logic Unit 510, Configuration Services 512, Data Source Services 514 and Archive Services 516. In one embodiment, the System Services 118 are software components that provide logical system level views. These components are preferably accessible from all physically deployed devices (e.g. via a distributed system middleware technology). Some of the System Services 118 provide wrapper and proxy access to commercial off-the-shelf (COTS) services that provide the underlying implementation of the System Services 118 (e.g., CORBA, Enterprise Java Beans, DCOM, RDBMS, SNMP agents/monitoring). The System Services 118 components can be deployed on multiple network nodes including SMC nodes and Image Database nodes. Each component of System Services 118 is described below.

In one embodiment, Configuration Services 512 is a CORBA interface that provides system configuration data for all subsystems. The Configuration Services 512 encapsulate system configuration and deployment information for the surveillance system 100. Given access to Configuration Services 512, any node (e.g., SMC 112, data depository 106) on the system 100 can configure itself for proper behavior, and locate and access all other required devices and nodes. More particularly, Configuration Services 512 will provide access to: (a) defined logical nodes of the system 100 and their location on physical devices, (b) defined physical devices in the system 100, (c) users and groups of users on the system 100 along with their authentication information, (d) the location of all services in the system 100 (e.g. a node finds Configuration Services 512, and then finds the Authorization Services 506, and then accesses the system 100), (e) defines data broadcast channels and the mapping between sensor devices (e.g., sensors 104a-c) and their data broadcast channels, (f) defines surveillance groups, and (g) defines security logic rules.

The Data Source Services 514 provide an abstraction (abstract base class) of all broadcast data channels and streaming data sources on the system. This includes video data (both from sensors and from playback), alarm devices data, and arbitrary data source plug-ins. This is preferably a wrapper service around system Configuration Services 512.

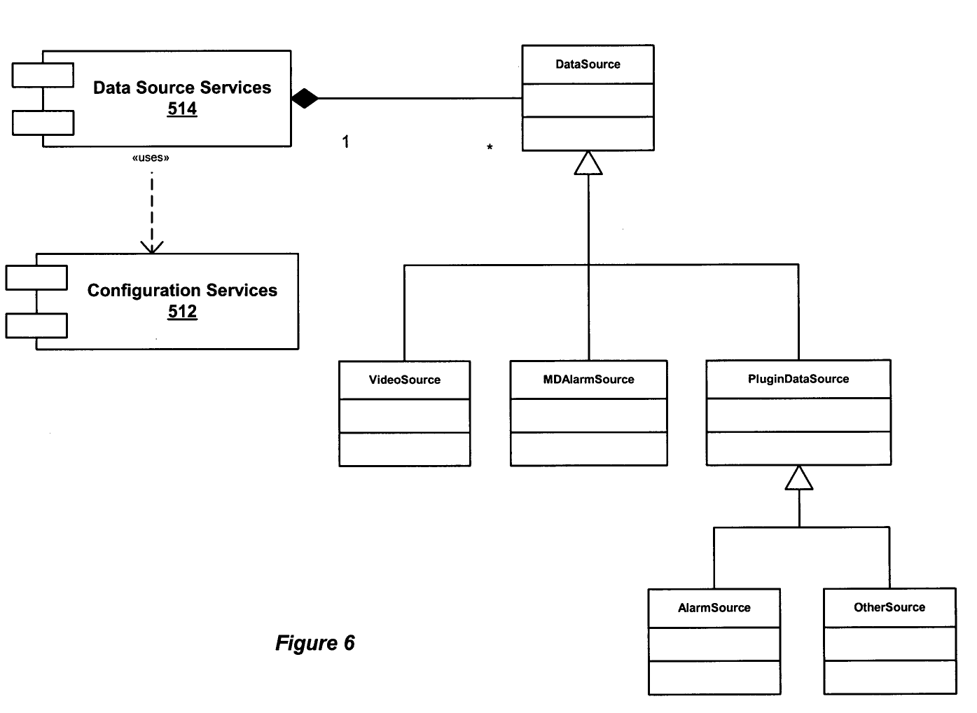

FIG. 6 is a diagram illustrating one example of a class hierarchy of the Data Source Services 514. The base class DataSource includes subclasses VideoSource (e.g., spherical video data), MDAlarmSource (e.g., motion detection event data) and PluginDataSource. The subclass PluginDataSource provides an abstract class for plug-in data sources and has two subclasses AlarmSource and OtherSource. Other classes can be added as additional types of data sources are added to the surveillance system 100.

The Authorization Services 506 is a CORBA interface that provides Authentication and Authorization data for all subsystems.

The Playback Services 508 is a CORBA interface that manages playback of image and non-image data from the Realtime Playback Spool 418, Incident Online Playback Spool 430 and the Incident Archive Playback Spool 422.

The Archive Services 516 is a CORBA interface that manages the contents of the Incident Archive Record Spool 420, the Incident Archive Playback Spool 422 and any tapes that are mounted in the system tape.

Time Services 502 provide system global time synchronization services. These services are implemented against a standard network time synchronization protocol (e.g. NNTP). Time services 502 can be provided by the operating system services.

System Status Monitor 504 monitors the status of all nodes in the surveillance system 100 via their status broadcast messages, or via periodic direct status query. This component is responsible for generating and logging node failure events, and power up/power down events.

Motion Detection Logic Unit (MDLU) 510 implements high level access of motion detection and object tracking that may not be implemented as primitive motion detection in the SSU 104a. At a minimum, the MDLU 510 handles the mapping between the level definition of guard zones and the individual motion detection zones and settings in the SSU 104a. It provides a filtering function that turns multiple motion detection events into a single guard zone alarm. It is also responsible for cross sensor object tracking.

### Surveillance System Operation

Having described the various subsystems of the surveillance system 100, the interoperation of these subsystems to provide surveillance will now be described.

The raw imagery captured by the spherical sensor is analyzed for motion detection operations and compressed in the SSU 104a before delivery to the network 102 as time-indexed imagery. Specifically, the spherical sensor sends bitmap data to the SSU 104a cards via a fiber optic connection. This data is sent as it is generated from the individual CCDs in the spherical sensor. In one embodiment, the data is generated in interleaved format across six lenses. The sensor interface 304 buffers the data into “slices” of several (8-16) video lines. These video lines are then sent to the motion detector 306 and image compressor 310. The image compressor 310 reads the bitmap slices (e.g., via a CCD driver which implements a Direct Memory Access (DMA) transfer across a local PCI bus) and uses the image compressor 310 to encode the bitmap slices. The encoded bitmap slices are then transferred together with motion detection Incidents to the image broadcaster 308. The image broadcaster reads the encoded bitmap slices (e.g., via a GPPS driver, which implements a DMA transfer across a local PCI bus), packetizes the bitmap slices according to a video broadcast protocol, and broadcasts the encoded bitmap slices onto the network 102 via the network interface 312. In parallel with image compression the bitmap slices are subject to motion detection analysis. In one embodiment, the results of the motion detection analysis are broadcast via a CORBA event channel onto the network 102, rather than communicated as part of the spherical video broadcasting information.

The image receiver 206 in the SD subsystem 114 subscribes to the multicasted spherical sensors and delivers the stream to the spherical display engine 218. This component uses the image decompressor 210 to decompress the imagery and deliver it to a high-resolution display via the CCI 212, operating system 214 and a video card (not shown). More particularly, decoded bitmaps are read from the JPEG decoder and transferred to a video card as texture maps (e.g., via the video card across a local AGP bus). Once all of the required bitmaps (and any other data) for the visible portion of a lens are available, the video card renders a video frame into a video memory buffer and performs lens de-warping, calibrated spherical seaming, video overlay rendering, translation, rotation, and scaling functions as required. Once all of the visible lenses have been rendered, the video display is updated on the next monitor refresh.

The rendering of multiple single view images into spherical video is described in U.S. Pat. No. 6,320,584, issued Nov. 20, 2001, U.S. patent application Ser. No. 09/970,418, filed Oct. 3, 2001, and U.S. application Ser. No. 09/697,605, filed Oct. 25, 2001, each of which is incorporated by reference herein.

Similarly, the image receiver 220 in the MD subsystem 116 subscribes to the multicasted spherical sensors and delivers a data stream to the MD engine 232. This component uses the image decompressor 224 to decompress the imagery and deliver it to a high-resolution display via the CCI 226, operating system 228 and a video card (not shown). The MD engine 232 renders a graphical map depiction of the environment under surveillance (e.g., building, airport terminal, etc.). Additionally, the MD engine 232 coordinates the operation of other workstations via interprocess communications between the CCI components 212, 226.

Similar to the subsystems 114, 116, the Data Repository Image Database 106 listens to the network 102 via the image receiver 404. This component is subscribed to multiple spherical imagery data streams and delivers them concurrently to the image recorder 406. The image recorder 406 uses an instance of the database manager 412, preferably an embedded RDBMS, to store the imagery on the high-availability SAN 110. An additional software component called the database control interface 414 responds to demands from the SMC 112 to playback recorded imagery. The database control interface 414 coordinates the image player 410 to read imagery from the SAN 110 and broadcasts it on the network 102.

### Video Broadcasting Protocol

The Video Broadcast protocol specifies the logical and network encoding of the spherical video broadcasting protocol for the surveillance system 100. This includes not only the raw video data of individual lenses in the spherical sensor, but also any camera and mirror state information (e.g., camera telemetry) that is required to process and present the video information.

The video broadcast protocol is divided into two sections: the logical layer which describes what data is sent, and the network encoding layer, which describes how that data is encoded and broadcast on the network. Preferably, software components are used to support both broadcast and receipt of the network-encoded data. Time synchronization is achieved by time stamping individual video broadcast packets with a common time stamp (e.g., UTC time) for the video frame. Network Time Protocol (NTP) is used to synchronize system clocks via a time synchronization channel.

### Logical Layer

The logical layer of the video broadcast protocol defines what data is sent and its relationships. Some exemplary data is set forth in Table I below:

TABLE I
Exemplary Data Types For Logical Layer

| Data Type | Description |
|---|---|
| Frame | A time stamped chunk of data. |
| Lens Frame | A complete set of JPEG blocks that make up a |
| | single lens of a spherical sensor. |
| Camera Telemetry | The settings associated with the spherical |
| | sensor and PTZ device, if any. |
| Spherical Frame | The frame for each lens, plus the camera |
| | telemetry frame. |
| Broadcast Frame | The set of data broadcast together as a |
| | spherical video frame. |

A Broadcast Frame contains the exemplary information set forth in Table II below:

TABLE II
Exemplary Broadcast Frame Data

| Data Type | Description |
|---|---|
| Protocol UID | Some unique identifier that indicates that this |
| | is a frame of the video broadcast protocol. |
| Version Number | The version number of the video broadcasting |
| | protocol (identifies the logical contents of the |
| | frame). |
| Encoding Version | Number used by the network-encoding layer to |
| Number | identify encoding details that do not affect the |
| | logical level. |
| Time Stamp | The UTC time of the broadcast frame. |
| Camera ID Information | Unique identifier for the sensor (e.g., sensor |
| | serial number) |
| Mirror Type Information | Unique identifier for the mirror system, if any. |
| Lens Color Plane | E.g., Gray, R, G1, G2, B, or RGB. |
| Lens Slices | Each lens is sent as a set of slices (1 . . . N), |
| | depending on video sources and latency |
| | requirements. |
| Position | Location of the slice in the lens. |
| Size | Size of the slice (redundantly part of the JPEG |
| | header, but simplifies usage). |
| Slice | The JPEG compressed data. |
| JPEG Q Setting | The quality setting used by the JPEG encoder |
| | (for internal diagnostic purposes). |
| Camera Telemetry | Information on the state of the sensor. |
| Information | |
| Lens Settings | The following information is provided for each |
| | lens setting. |
| Lens Shutter Speed | The shutter speed value of the individual lenses |
| | when the frame was generated. |
| Gain | The gain values for the individual lenses when |
| | the frame was generated. |
| Auto Gain | The value of the sensor's auto gain settings |
| | when the frame was generated (on/off). |
| Frame Rate | Operational frame rate that data is |
| | captured/displayed. |
| Sensor Location | The sensor's location relative to the current |
| Information | map (i.e., latitude, longitude and elevation). |
| Sensor Attitude | The sensor's installation heading (relative |
| Information | North), pitch and bank adjustment from the |
| | ideal of perfectly level. |
| Zoom (Z) | The zoom value, Z, of any high resolution lens, |
| | preferably expressed as a Field of View (FoV) |
| | value |
| Iris (I) | The current iris setting, I, of any high |
| | resolution lens (other lens have fixed irises) |
| Focus (F) | The focus value, F, of any high resolution lens |
| Mirror Moving Flags | Boolean value for each degree of freedom in |
| | the mirror (bH, bP, bZ, bF, bI). |

### Multicasting

In one embodiment of the present invention, IP multicasting is used to transmit spherical data to multiple receiving sources. Broadcasters are assigned a multicast group address (or channel) selected from the “administrative scoped” multicast address space, as reserved by the Internet Assigned Numbers Authority (IANA) for this purpose. Listeners (e.g., SMC 112, Data Repository Image Database 106) subscribe to multicast channels to indicate that they wish to receive packets from this channel. Broadcasters and listeners find the assigned channel for each sensor by querying the Configuration Services 512. Network routers filter multicast packets out if there are no subscribers to the channels. This makes it possible to provide multicast data to multiple users while using minimum resources. Multicasting is based on the User Datagram Protocol (UDP). That means that broadcast data packets may be lost or reordered. Since packet loss is not a problem for simple LAN systems, packet resend requests may not be necessary for the present invention. Multicast packets include a Time to Live (TTL) value that is used to limit traffic. The TTL of video broadcast packets can be set as part of the system configuration to limit erroneous broadcasting of data.

### Channels

IP multicast group addresses consist of an IP address and port. Broadcast frames are preferably transmitted on a single channel. One channel is assigned to each SSU. Video repository data sources allocate channels from a pool of channel resources. Each channel carries all data for that broadcast source (e.g., all lens data on one channel/port). Channel assignment will conform to the requirements of industry standards. IP Multicast addresses are selected from “administrative scoped” IP Multicast address sets. Routers that support this protocol are used to limit traffic. Other data sources (e.g., motion detection event data) are sent via CORBA event channels. Alternatively, such other data sources can be sent using a separate channel (e.g., same IP, different port) or any other distributed system middleware technology.

### Byte Encoding

Byte encoding defines the specifics of how host computer data is encoded for video broadcast transmission. JPEG data may safely be treated as a simple byte stream. Other data defined as binary encoding should address this issue. In practice, there are at least two options: encode to a common data format for transmission or optimize for a homogeneous system by encoding a byte-encoding indicator in the packet information.

### Packetization

Preferably, the video broadcast protocol converts broadcast frame information into IP packets. To address the issues of packet loss and packet reordering, these packets typically will include redundant information. Experiments with IP Multicasting on 100 Mbs CAT-5 networks shows that good throughput was produced when using the largest packet size possible. Thus, it is preferable to transmit the largest packets possible. The individual JPEG blocks, however, can be shipped as soon as they are available from the encoder.

Packets preferably include a common packet header and a data payload. For the surveillance system 100, the data payload will either be a JPEG or a JPEG continuation. JPEG continuations are identified by a non-zero JPEG byte offset in the JPEG payload section. Video display information includes information for proper handling of the JPEGs for an individual lens. This information is encoded in the JPEG comment section. The comment section is a binary encoded section of the JPEG header that is created by the JPEG encoder. Table III is one example of a packet header format.

TABLE III
Exemplary Packet Header Format

| Bit | Size/Type | Name | Description |
|---|---|---|---|
| 0 | 32/unsigned | Protocol ID | Unique identifier for |
| | | | protocol |
| | | | Value: To be assigned |
| 32 | 8/unsigned | Version | Protocol Version |
| | | | Number: |
| | | | Value: 1 |
| 40 | 8/unsigned | Encoding Version | Encoding Version |
| | | | Number: |
| | | | Value: 1 |
| 48 | 16/unsigned | Sequence Number | Monotonically |
| | | | increasing sequence |
| | | | number used to detect |
| | | | missing/out of order |
| | | | packets |
| 64 | 16/unsigned | Packet Size | Total size of the packet |
| | | | (should be consistent |
| | | | with received size) |
| 80 | 16/unsigned | Payload Offset | Byte offset from the |
| | | | beginning of the packet |
| | | | data payload (Packet |
| | | | Size − Payload Offset = Payload |
| | | | size) |
| 96 | 32/unsigned | Camera ID | The sensor ID value |
| 128 | 16/unsigned | Lens ID | Lens of the particular |
| | | | sensor type |
| 144 | 8/unsigned | Slice Number | The number of the |
| | | | slice on the lens |
| 152 | 8/unsigned | Pad1 | Reserved |
| 160 | 32/unsigned | Slice Byte Offset | The data payload's |
| | | | byte offset in the slice |
| | | | that it came from. This |
| | | | allows slices that |
| | | | exceed the allowable |
| | | | maximum packet size |
| | | | to be split up. |
| 192 | 32/unsigned | Total Slice Size | Total size of the JPEG |
| | | | (usually the size of the |
| | | | payload data) |
| 224 | 32/unsigned | Payload Data | The actual bytes of the |
| | | | payload, containing |
| | | | partial/whole JPEG |

### JPEG Comment Section

The JPEG comment section is found in the JPEG header. It is standard part of JPEG/JIFF files and consists of an arbitrary set of data with a maximum size of 64K bytes. The following information can be stored in the JPEG comment section: Camera ID, Time Stamp, Lens ID, Color Plane, Slice information: (X, Y, W, H) offset, JPEG Q Setting, Camera Telemetry (Shutter Speed, Auto Gain Setting, Master/Slave Setting, Gain Setting, Frame Rate, Installed location and attitude , Mirror Telemetry). This data can be encoded in the JPEG comment sections in accordance with publicly available JPEG APIs.

### Motion Detection & Object Tracking

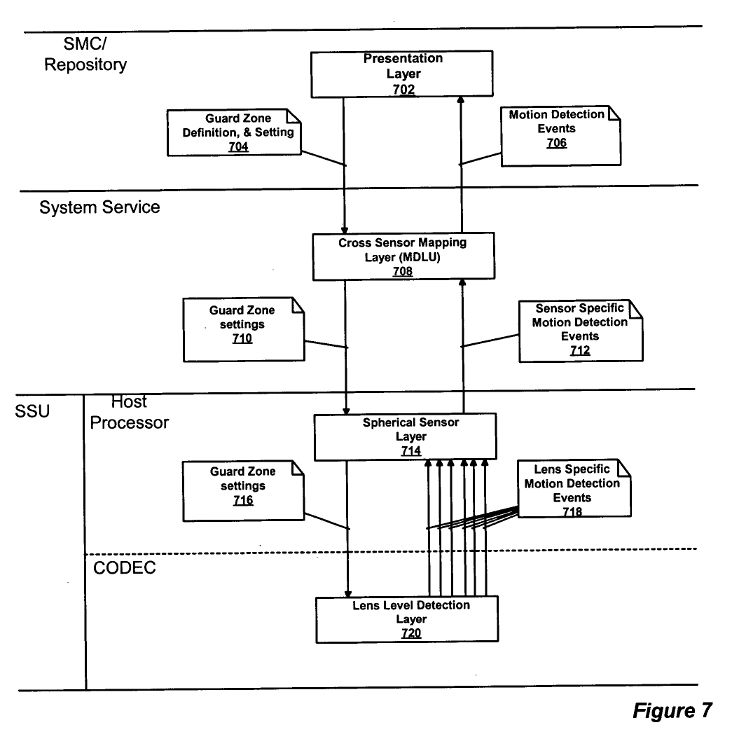

The implementation of motion detection and object tracking in the surveillance system 100 balances the needs of the user interface level against the needs of the image analysis algorithms used to implement it. Surveillance personnel are focused on providing security for well-defined physical areas of interest at the deployed site. The most natural user interface will allow surveillance personnel to manipulate guard zones in terms of these areas. Multiple spherical sensors will inevitably provide multiple views of these areas of interest; therefore, user interface level Guard Zones (defined below) are preferably defined to overlap multiple spherical sensors. At the lowest level, motion detection algorithms are implemented as image manipulations on the raw video data of individual lenses in a spherical sensor. These algorithms perform well when they have access to the original video image because compression technologies introduce noise into the data stream. These issues are addressed by a motion detection protocol, which describes the communication between the user interface level and the implementation in individual sensors and includes four levels, as shown in FIG. 7.

FIG. 7 is a block diagram illustrating the four layers in the motion detection protocol, in accordance with one embodiment of the present invention. The four layers of the motion detection protocol are (from top to bottom) the Presentation Layer, the Cross Sensor Mapping Layer, the Spherical Sensor Layer, and the Lens Level Detection Layer.

The Presentation Layer deals with providing the user interface for Guard Zones and displaying motion detection alarm events to the operator. This layer can also be used by log functions that capture and log alarm events. The Presentation Layer is preferably deployed as software components on the SMC 104a and optionally on the Data Repository 106.

The Cross Sensor Mapping Layer (MDLU 510) addresses the need to divide up user interface level Guard Zones into a set of sensor specific motion detection zones. Ia.t manages the receipt of motion detection events from individual sensors and maps them back into Guard Zone events. It supports multiple observers of guard zone events. It is responsible for any cross lens sensor object tracking activities and any object identification features. In one embodiment, it is deployed as part of the system services 118.

The Spherical Sensor Layer manages the conversion between motion detection settings in spherical space and lens specific settings in multi-lens sensors. This includes conversion from spherical coordinates to calibrated lens coordinates and vice versa. It receives the lens specific sensor events and converts them to sensor specific events filtering out duplicate motion detection events that are crossing lens boundaries.

The Lens Level Detection Layer handles motion detection on individual sensors. It provides the core algorithm for recognizing atomic motion detection events. It is preferably deployed on the hardware layer where it can access the image data before compression adds noise to the imagery.

### Motion Detection Overview

FIG. 8 is a block diagram illustrating a motion detection process, in accordance with one embodiment of the present invention. The motion detection subsystem 800 implements the processes 714 and 720. It receives video frames and returns motion detection events. It detects these events by comparing the current video frame to a reference frame and determines which differences are significant according to settings. These differences are processed and then grouped together as a boxed area and delivered to the network 102 as motion detection events. The subsystem 800 performs several tasks simultaneously, including accepting video frames, returning motion detection events for a previous frame, updating the reference frame to be used, and updating the settings as viewing conditions and processor availability changes. If frames are received from the spherical sensor faster than they can be processed, the subsystem 800 will perform one of several procedures, including prematurely terminating the analysis of a video frame, modifying the settings to reduce the number of events detected, dropping video frames or prioritizing Guard Zones so that the most important zones are analyzed first. In another embodiment, a motion detection subsystem would be implemented on dedicated processors that only handle motion detection events, with video compression occurring on different processors.

### Motion Detection Subsystem

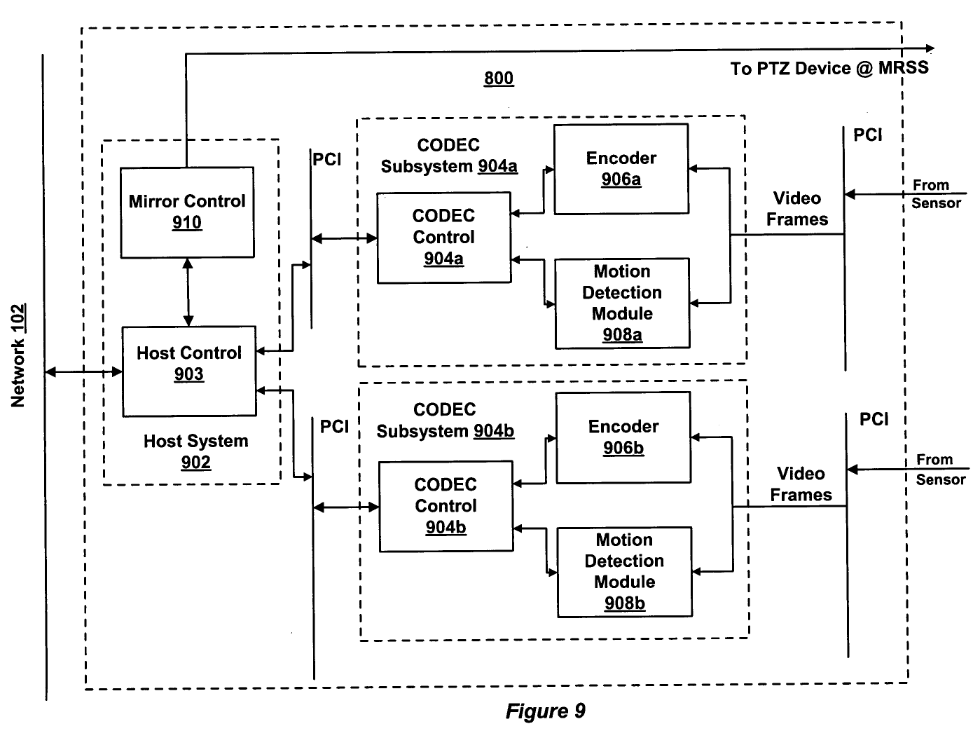

FIG. 9 is a block diagram of a motion detection subsystem 800, in accordance with one embodiment of the present invention. In the embodiment described the motion detection subsystem 800 is part of the SSU 104a and includes a host system 902 (e.g., motherboard with CPU) running one or more control programs that communicate with external systems via the network 102 and CODEC subsystems 904a-b (e.g., daughter boards with CPUs). Preferably, the motion detection algorithms are implemented in software and executed by the CODEC subsystems 904a-b. In this configuration the CODEC subsystems 904a-b will have their own control programs since they will also handle compression and video frame management functions. Since each CODEC subsystems 904a-b will independently process a subset of a spherical sensor's lens, the host system 902 software will contain one or more filters to remove duplicate motion detection events in areas where the lenses overlap.

One or more sensors send video frames over, for example, a fiber optic connection to the SSU 104a, where they are transferred to an internal bus system (e.g., PCI). Under the control of CODEC controls 904a-b, the video frames are analyzed for motion detection events by motion detection modules 908a-b and compressed by encoders 906a-b (e.g., JPEG encoding units). The encoded video frames and event data are then delivered to the network 102 by host control 903. The host control 903 uses the event data to issue commands to the mirror control 910, which in turn controls one or more PTZ devices associated with one or more MRSS devices. Thus, if motion is detected in a lens of a spherical sensor, the PTZ device can be automatically or manually commanded to reposition a mirror for reflecting imagery into the lower lens of a MRSS type spherical sensor to provide high-resolution detail of the area where the motion was detected.

In security or reconnaissance applications with real time viewing of imagery, if the user decides that one particular area is more interesting than the rest of the imagery, the system 100 can be configured to increase the resolution of the area of interest by tiling together multiple single view images from the high resolution lens (assuming the area of interest is larger than the field of view of the high resolution lens), while decreasing the frame rate of all but the wide-angle lens covering the area of interest. This technique can provide better resolution in the area of interest without increasing the transmission bandwidth of the system 100.

### Cross-Lens Functional Requirements

Since the surveillance sensors are multi-lens, motion detection will need to span lenses. To simplify the low-level motion detection computations, the majority of the motion detection is done on each of the lenses independently. The cross-lens requirements can be implemented as a filter, which removes or merges duplicate motion detection events and reports them in only one of the lenses. This partition also makes sense due to the physical architecture. Only the host system 902 is aware of the multi-lens structure. Each of its slave CODEC subsystems 904a-b will process a subset of the lenses and will not necessarily have access to neighboring lens data. The motion detection filter will either have access to calibration information or be able to generate it from the lens information and will translate the coordinates from one lens to the corresponding coordinates on overlapping lenses.

The cross lens motion detection functionality includes receiving input from the CODEC subsystems 904a-b (e.g., motion detection events, calibration negotiation), receiving input from the network 102 (e.g., requests to track an object), sending output to the CODEC subsystems 904a-b (e.g., request to track an object), sending output to the network 102 (e.g., lens to lens alignment parameters (on request), broadcasted filtered motion detection events (with lens and sensor ID included), current location of tracked objects).

### Single Lens Functional Requirements

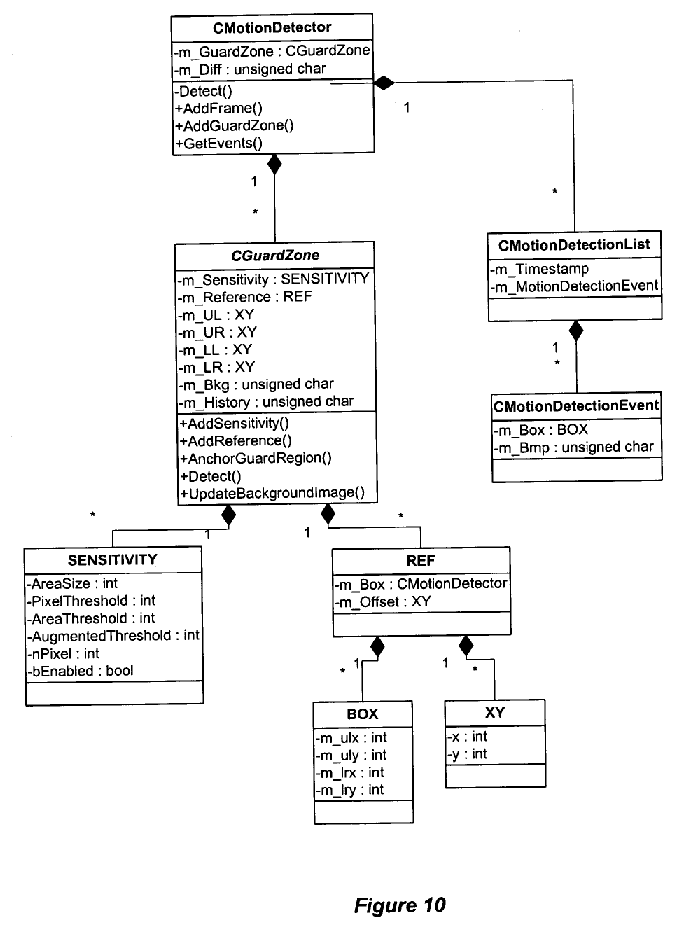

FIG. 10 is diagram illustrating a class hierarchy of a motion detection subsystem, in accordance with one embodiment of the present invention. Each lens of a spherical sensor is associated with a software class hierarchy CMotionDetector. CMotionDetector is responsible for the bulk of the motion detection effort. This includes calculating motion detection events, maintaining a current reference frame and tracking objects. More particularly, the functional requirements include, without limitation, adding video frames, getting/setting settings (e.g., add/delete motion detection region, maximum size of a motion detection rectangle, maximum size of returned bitmap in motion detection event), tracking objects, receiving commands (e.g., enable/disable automatic calculation of ranges, enable/disable a motion detection region, set priority of a motion detection region, set number of frames used for calculating a reference frame, calculate a reference frame, increase/decrease sensitivity), posting of motion detection events, posting of automatic change of settings, posting of potential lost motion events, and current location of tracked objects. Each motion detection class is discussed more fully below.

### CMotionDetector

CmotionDetector performs overall control of motion detection in a lens. It contains a pointer to the previous frame, the current frame, and a list of CGuardZone instances.

Its principal public operations include but are not limited to: AddGuardZone( ): Add a new CGuardZone object to be analyzed. AddFrame( ): Add a frame and its timestamp to the queue to be analyzed. GetEvents( ): Returns the next CMotionDetectionList, if available. If it is not yet available, a NULL will be returned.

Internally, there is a lower priority analysis thread that performs the actual motion detection analysis. AddFrame( ), thus simply adds a frame to the queue, and GetEvents( ) will return a list only if the analysis is complete (or terminated). To tie the CMotionDetectionList back to the frame from which it was derived the timestamp is preserved.

### CGuardZone

This class defines an area within a CMotionDetector in which motion is to be detected. The CGuardZone may have reference boxes, which are used to adjust (or stabilize) its position prior to motion detection. Each CGuardZone instance has a list of References and a list of Sensitivities. Each Guard Zone keeps its own copy of the values of its previous image and its background image. This allows overlapping Guard Zones to operate independently, and to be stabilized independently. A Guard Zone also keeps a history of frames, from which it can continuously update its background image.

The principle public operations include but are not limited to: AddSensitivity( ): Add a sensitivity setting to the Guard Zone, AddReference( ): Add a reference box to the Guard Zone, which will be used to stabilize the image prior to performing motion detection. AnchorGuardRegion( ): Using the Reference boxes, find the current location of the Guard Zone in the frame. It will be found to an accuracy of ¼ a quarter of a pixel. Detect( ): Determine the “in-motion” pixels by comparing the stabilized Guard Zone from the current frame with the reference (or background) image. UpdateBackgroundImage( ): Add the stabilized Guard Zone from the current frame to the history of images, and use the history to update the reference (or background) image.

### CMotionDetectionList

This class is a list and contains a timestamp and a list of CMotionDetectionEvent's.

### CMotionDetectionEvent

This class defines an area in which motion has been detected and an optional bitmap of the image within that box. An important feature of the CMotionDetectionEvent is a unique identifier that can be passed back to CMotionDetector for tracking purposes. Only the m_count field of the identifier is filled in. The m_lens and m_sensor fields are filled in by host control 903 (See FIG. 9).

### Significant Structures

In one embodiment of the present invention, all images are one byte per pixel (gray scale) and are in typical bitmap order; row zero is the bottom most row and therefore the upper left corner of a box will have a greater y value than the bottom left corner.

Reference is a structure, which defines a rectangle used to anchor a Guard Zone. Typically it will mark a region within the Guard Zone that can be expected to be found from one frame to another and be relatively free of motion. It is preferably to place them in opposite corners.

Sensitivity contains information on how to determine whether pixel differences are significant. For a specific size of analysis area, a minimum pixel difference is given, plus the minimum number of pixels which must exceed that difference, plus a minimum summation that the pixels which at least meet the minimum pixel difference must exceed. All conditions must be met for any of the pixels to be counted as being in motion.

XY is a structure that includes the x, y pixel coordinate on the CCD lens image.

### Cross-Lens Design

The main requirement of cross-lens motion detection is to filter out duplicate motion detection events. A secondary requirement is to track objects, especially across lenses. A third function is dynamic lens alignment calibration.

### Filtering Duplicate Motion Detection Events

The host system 902 receives motion detection events from the various lenses in the spherical sensor and knows the calibration of the lenses. Using this information, it checks each motion detection event on a lens to determine if an event has been reported at the equivalent location on a neighboring lens. If so, it will merge the two, and report the composite. For purposes of tracking, the ID of the larger of the two, and its lens are kept with the composite, but both ID's are associated at the host system 902 level so that it can be tracked on both lenses.

### Object Tracking

In one embodiment of the present invention, object tracking is performed using a “Sum of Absolute Differences” technique coupled with a mask. One example of a mask that can be used is the pixels that were detected as “in-motion”. This is the primary purpose of the “Augmented Threshold” field in the Sensitivity structure shown in FIG. 10. It gathers some of the pixels around the edge of the object, and fills in holes where pixel differences varied only slightly between the object and the background. Once a mask has been chosen for an object, the mask is used to detect which pixels are used in calculating the sum of absolute differences, and the closest match to those pixels is found in the subsequent frame. Having determined the location of the object, its current shape in the subsequent frame is determined by the pixels “in-motion” at that location, and a new mask for the object is constructed. This process repeats until the tracking is disabled or the object can no longer be found.

One difficulty with tracking is that by the time the operator has pointed to an object and the information gets back to the CODEC subsystems 904a-b many frames have passed. Also, it would desirable to identify an object by a handle rather than a bitmap (which may be quite large). Each lens therefore generates a unique integer for its motion detection events. The host system 902 adds a lens number so that if the ID comes back it can be passed back to the correct CMotionDetector structure. CMotionDetector will keep a history of its events so that it will have the bitmap associated with the event ID. Once the operator has identified the object to be tracked, it is located in the frame (the ID contains both a frame number and an index of the motion box within that frame), and the object is tracked forward in time through the saved bitmaps to the current “live” time in a similar manner to that described in the previous section.

### Calibration

Given that the SSU 104a already has the capability to perform matching, the host system 902 requests one CMotionDetector structure to return a bitmap of a particular square and asks another structure to find a matching location starting the search at an approximate location. The host system 902 scans down the edges of each lens and generates as many points as desired, all with about ¼ pixel accuracy. This works except in the case where the image is completely uniform. In fact, slowly varying changes in the image are more accurately matched than areas of sharp contrast changes. This allows dynamic calibration in the field and automatically adjusts for parallax. An additional capability is provided for matching is the ability to request a report of the average intensity for a region of a lens so that the bitmap to be matched can be adjusted for the sensitivity difference between lenses. This is useful information for the display (e.g., blending).

### Single Lens Design

The majority of the motion detection work is performed on each of the lenses separately. The detection is directed by the settings, and performed only on the areas known as Guard Zones. A reference frame is maintained and object tracking is performed at this level.

The motion detection settings may vary from lens to lens, and even Guard Zone to Guard Zone. The calculation of the reference frame is actually calculated for each of the Guard Zones in a lens, and not for the lens as a whole. In one embodiment, one lens' motion detection unit calculates a new group of settings then slaves the other motion detection units to the settings. For example, the host system 902 can fetch the current settings from a Guard Zone on one lens and them send them to all existing Guard Zones.

### Data Flow

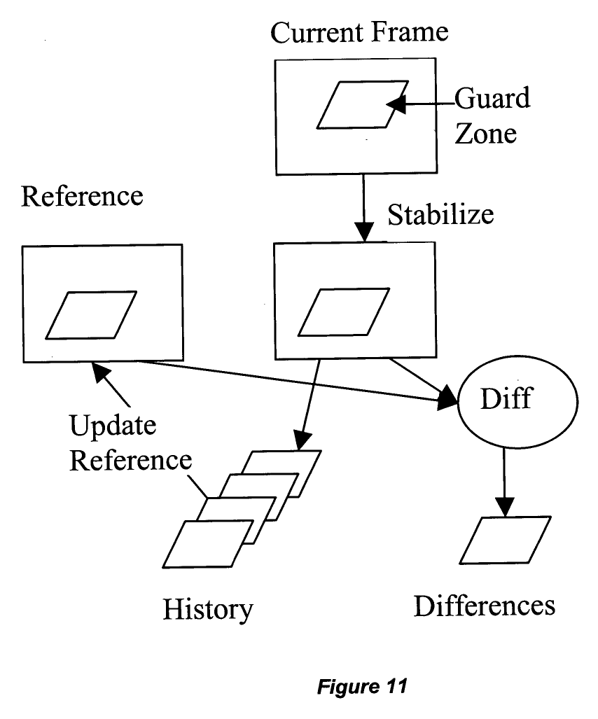

FIG. 11 is a diagram illustrating data flow in the motion detection subsystem, in accordance with one embodiment of the present invention. CMotionDetector class retrieves the current frame and each CGuardZone instance is requested to find the current location of its area (stabilization), and then calculate the raw differences between the stabilized Guard Zone and the Reference. The differences are stored in a full-frame image owned by CMotionDetector. This merges all raw motion reported by each of the Guard Zones. The CGuardZone instances are then requested to save the stabilized image in a circular history and use it to update their reference Guard Zone image.

### Stabilizing

If a Guard Zone is stabilized, the motion detection is performed on the frame's image after it has been moved to the same coordinates as it exists in the reference image and the original image is left intact. To achieve stabilization, a copy of the original image is made to the same position as the reference frame. Thus, once a motion detection event is created, the coordinates of the motion detection areas are translated to their locations in the original image and the pixel values returned come from the translated image of the Guard Zone. Moreover, the Guard Zone keeps a copy of the translated image as the previous frame image. This is used for tracking and background updates.

### Motion Detection Data Objects

The implementation of the motion detection algorithm is a multi-step process and is split between the CMotionDetector class and the CGuardZone class. This split allows each Guard Zone to be stabilized independently and then analyzed according to its settings, and could even overlap with other guard zones. Once pixels are detected as “in-motion,” the CMotionDetector object groups the pixels into objects, which are reported. In one embodiment of the present invention, the steps are as follows:

Step 1: The CMotionDetector clears the m_Diff bitmap.

Step 2: CmotionDetector then calls each of the CGuardZone instances to find (stabilize) their Guard Zone image in the current frame. This is performed if there are reference points and stabilizing is enabled. The Guard Zone will be located by finding the nearest location in the current frame, which matches the reference boxes in the previous frame to a resolution of ¼ pixel.

Step 3: CMotionDetector calls each of the CGuardZone instances to detect “in-motion” pixels for their regions. It may stop prematurely if asked to do so. The “in-motion” pixels are determined by the Sensitivity settings for each guard zone.

Step 4: CMotionDetector then gathers the pixels “in-motion” into motion detection events.

### Motion Detection Algorithms

In one embodiment of the present invention, the detection of motion is accomplished in two passes. The first pass involves the execution of a pixel analysis difference (PAD) algorithm. The PAD algorithm analyzes the raw pixels from the sensor and performs simple pixel difference calculations between the current frame and the reference frame. Preferably, the reference frame is the average of two or more previous frames with moving objects excluded. Each pixel of the reference frame is calculated independently, and pixels in the reference frame are not recalculated as long as motion is detected at their location. The results of PAD are a set of boxes (Motion Events), which bound the set of pixels that have been identified as candidate motion.

The second pass involves the execution of an analysis of motion patterns (AMP) algorithm, which studies sequences of candidate motion events occurring over time and identifies those motion sequences or branches that behave according to specified rules, which describe “true” patterns of motion. For example, a motion rule for velocity comprises thresholds for the rate of change of motion event position from frame to frame, as well as the overall velocity characteristics throughout the history of the motion branch. A set of motion rules can all be applied to each motion branch. The results of AMP are motion event branches that represent the path of true motion over a set of frames. New motion rules can be created within the AMP code by deriving from CMotionRules class. A vector of motion rules (e.g., velocity motion rule) are applied to one or more candidate motion branches to determine if it is true motion or false motion.

The parameters for tuning the PAD algorithm are encapsulated in Sensitivity settings. In one embodiment, there are six parameters that control the PAD algorithm. These parameters include but are not limited to: AreaSize, PixelThreshold, AreaThreshold, OverloadThreshold, NumPixels, and AugmentedThreshold. Each of these parameters is described below.

AreaSize—The AreaSize defines the dimensions of a square that controls how PAD scans and analyzes the motion detection region. If the AreaSize is set to a value of 5 then groups of 25 pixels are analyzed at a time. A standard daytime 100-meter guard zone setting for AreaSize is in the range of 3 to 5.

PixelThreshold—The PixelThreshold is compare used to compare the difference in pixel values between pixels in the current frame and the reference frame. If the pixel value differences are equal to or greater than the PixelThreshold, PAD will identify those as candidate motion. The standard daytime setting for PixelThreshold is in the range of 15 to 30. This PixelThreshold calculation for each pixel in the region is the first test that PAD performs.

OverloadThreshold—The OverloadThreshold is used to compare to the total percentage of pixels within the motion detection region that satisfy the PixelThreshold. If that percentage is equal to or greater than the OverloadThreshold then PAD will discontinue further pixel analysis for that frame and skip to the next one. The OverloadThreshold calculation for the region is the second test that PAD performs.

NumPixels—The NumPixels is used to compare to the total number of pixels within the AreaSize that meet the PixelThreshold. If the number of pixels that exceed the PixelThreshold is equal to or greater than the NumPixels then PAD identifies them as candidate motion. If the AreaSize is 5 and NumPixels is 7, then there must be 7 or more pixels out of the 25 that satisfy the PixelThreshold in order to pass the NumPixel threshold.

AreaThreshold—The AreaThreshold is used to compare to the sum of all the pixel differences that exceed the PixelThreshold within the AreaSize. If the sum is equal to or greater than this AreaThreshold then PAD will identify them as candidate motion. If the AreaSize is 5, NumPixels is 15, PixelThreshold is 10, AreaThreshold is 200, and 20 of the 25 pixels change by a value of 20, then the sum is 400 and therefore the AreaThreshold is satisfied.

AugmentedThreshold—This threshold is used to augment the display of the pixels with adjacent pixels within the AreaSize. This threshold value is used to compare to the pixel difference of those neighboring pixels. If the pixel differences of the adjacent pixels are equal to or greater than the AugmentedThreshold than those are also identify as candidate motion. The Augmented threshold calculation is performed on areas that satisfy the NumPixels and AreaThreshold minimums. It is used to help analyze the shape and size of the object.

### Matching

There are many algorithms that have been developed for performing image matching. These include outline matching (snakes), edge detection and pattern matching, Sum of Absolute Differences (SADMD) among others. A preferred method used in the surveillance system 100 is SADMD. It was chosen for its versatility, tolerance of some shape changes, and its amenability to optimization by SIMD instruction sets. This basic tracking algorithm can be used for stabilizing a guard zone as well as tracking an object that has been detected. It can also be used to generate coordinates useful for seaming and provide on-the-fly parallax adjustment. In particular, it can be used to perform cross-lens calibration on the fly so that duplicate motion detection events can be eliminated. There are two flavors of SADMD that are used in the present invention. The first is a fast algorithm that operates on a rectangular area. The other uses a mask to follow an irregularly shaped object. Matching is a function of the entire lens (not just the guard zone), and therefore is best done on the original bitmap. Preferably it is done to a ¼ pixel resolution in the current implementation.

### Object Tracking

Objects that are being tracked may be rectangular (e.g. reference points), or arbitrarily shaped (most objects). If there is a mask, ideally it should change shape slightly as it moves from frame to frame. The set of “in-motion” pixels will be used to create the mask. Thus, in an actual system, a CMotionDetectionEvent that was identified in one frame as an object to be tracked will be sent back (or at least its handle will be sent back) to the CMotionDetector for tracking. Many frames may have elapsed in the ensuing interval. But the CMotionDetector has maintained a history of those events. To minimize the search and maintain accuracy, it will start with the next frame following the frame of the identified CMotionDetectionEvent, find a match, and proceed to the current frame, modifying the shape to be searched for as it proceeds.

### Background Frame Calculation

As described above, the basic motion detection technique is to compare the current frame with a reference frame and report differences as motion. The simplest choice to use as a reference is the preceding frame. However, it has two drawbacks. First, the location of the object in motion will be reported at both its location in the preceding frame and its location in the current frame. This gives a “double image” effect. Second, for slow-moving, relatively uniformly colored objects, only the leading and trailing edge of the object is reported. Thus, too many pixels are reported in the first case and too few in the second. Both cases complicate tracking.

A preferred method is to use as a reference frame a picture of the image with all motion removed. An even better choice would be a picture, which not only had the motion removed, but was taken with the same lighting intensities as the current frame. A simple, but relatively memory intensive method, has been implemented to accomplish the creation and continuous updating of the reference frame. The first frame received becomes the starting reference frame. As time goes on, a circular buffer is maintained of the value of each pixel. When MAX_AVG frames have elapsed wherein the value of the pixel has not varied by more than a specified amount from the average over that period, the pixel is replaced with the average.

### Launch Display(LD)

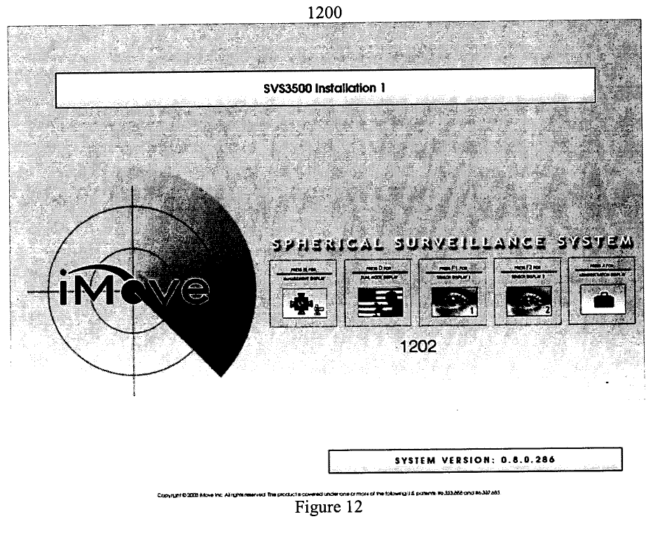

FIG. 12 is a screen shot of a LD 1200, in accordance with one embodiment of the present invention. The LD 1200 is one of several user interface displays presented to a surveillance operator at the SMC 112. In one embodiment the LD 1200 is used to start one or more of the following SMC applications, the Management Display (MD), the Sensor Display (SD) or the Administrative Display (AD) by selecting one of the options presented in the button menu 1202.

### Management Display (MD)

FIG. 13 is a screen shot of a MD 1300, in accordance with one embodiment of the present invention. The MD 1300 is one of several user interface displays presented to a surveillance operator at the SMC 112. The MD 1300 includes a sensor system map 1302, a function key menu 1304 and a series of tabs 1306. The MD 1300 also includes one or more control devices (e.g., full keyboard and trackball) to allow the surveillance operator to login/logout of the SMC 112, monitor sensor status, navigate the sensor system map 1302, initiate Incidents, view information about the surveillance system 100 and archive and playback Incidents.

In one embodiment of the present invention, a Guard Zone is an area within a sensor's spherical view where it is desired that the sensor detect motion. Each Guard Zone includes a motion detection zone (MDZ), paired with a user-selectable motion detection sensitivity setting. The MDZ is a box that defines the exact area in the sensor's field of view where the system 100 looks for motion. A MDZ is composed of one or more motion detection regions (MDR). The MDR is what motion detection analyzes.

In one embodiment of the present invention, an Incident is a defined portion of the video footage from a sensor that has been marked for later archiving. This allows an operator to record significant events (e.g., intrusions, training exercises) in an organized way for permanent storage. An Incident is combined with information about a category of Incident, the sensor that recorded the Incident, the start and stop time of the Incident, a description of the Incident and an Incident ID that later tells the system 100 on which tape the Incident is recorded.

One purpose of the MD 1300 is: (1) to provide the surveillance operator with general sensor management information, (2) to provide the sensor system map 1302 of the area covered by the sensors, (3) to adjust certain sensor settings, (4) to enable the creation, archiving and playback of incidents (e.g., motion detection events), (5) to select which sensor feeds will appear on each Sensor Display and (6) to select which Sensor Display shows playback video. The MD 1300 provides access to sensor settings and shows the following information to provide situational awareness of a site: sensor system map 1302 (indicates location of sensor units, alarms, geographical features, such as buildings, fences, etc.), system time (local time), system status (how the system is working), operator status (name of person currently logged on) and sensor status icons 1308 (to show the location of each sensor and tell the operator if the sensor has an alarm, is disabled, functioning normally, etc.)

The sensor system map 1302 shows where sensors are located and how they are oriented in relation to their surroundings, the status of the sensors and the direction of one or more objects 1310 triggering Guard Zone alarms on any sensors. The sensor system map 1302 can be a two-dimensional or three-dimensional map, where the location and orientation of a sensor can be displayed using sensor location and attitude information appropriately transformed from sensor relative spherical coordinates to display coordinates using a suitable coordinate transformation.

The function key menu 1304 shows the operator which keyboard function keys to press for different tasks. Exemplary tasks activated by function keys are as follows: start incident recording, login/logout, silence alarm, navigate between data entry fields, tab between tab subscreens 1306, and initiate playback of incidents. The specific function of these keys changes within the context of the current subscreen tab 1306.

Subscreen Tabs 1306 allow the operator to perform basic operator administrative and maintenance tasks, such as logging on to the SMC 112. Some exemplary tabs 1306 include but are not limited to: Guard Zones (lets the operator adjust the sensitivity of the Guard Zones selected), Incidents (lets the operator initiate an Incident, terminate an Incident, record data for an alarm initiated Incident, squelch an Incident), Online Playback Tab and an Archive Playback Tab (lets the operator archive Incidents from either offline tape storage tape via the Incident Archive Playback Spool or from the Incident Online Playback Spool).

### Sensor Display (SD)

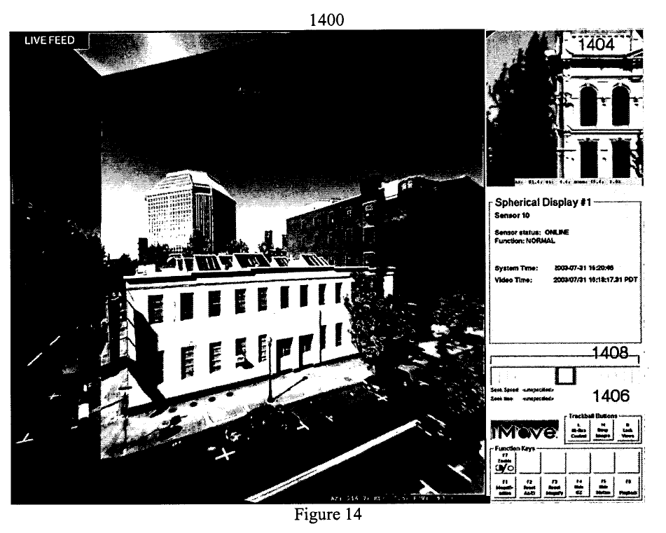

FIG. 14 is a screen shot of an SD 1400, in accordance with one embodiment of the present invention. The SD 1400 includes a spherical view 1402, a high-resolution view 1404, a function key menu 1406 and a seek control 1408. It also displays the following information about the SD 1400: real-time display (indicates whether the display is primary or secondary), sensor status (states whether sensor is working), sensor ID (indicates the sensor from which the feed comes), feed (“live” or “playback”), azimuth, elevation, field of view, zoom (shows camera direction and magnification settings for the spherical and high resolution views), repository start (indicates the current starting point for the last 24 hours of recorded footage), system time (current local time) and a current timestamp (time when current frame was captured).

One purpose of the SD 1400 is to show sensor images on the screen for surveillance. Specifically, the SD 1400 has immersive and high resolution imagery combined on one display, along with one or more control devices (e.g., keyboard and trackball). This allows an operator to see potential threats in a spherical view, and then zoom in and evaluate any potential threats. The operator can perform various tasks, including navigating views and images in the SPD 1400, panning, tilting, switching between the high resolution control and spherical view control, locking the views, swapping the spherical view 1402 and the high resolution view 1404 between large and small images and zooming (e.g., via the trackball).

The function key menu 1406 shows the operator which keyboard function keys to press for different tasks. Exemplary tasks activated by function keys include but are not limited to actions as follows: start, stop, pause playback, adjust contrast and brightness, magnify, zoom and toggle displays 1402 and 1404.

### Administrative Display (AD)

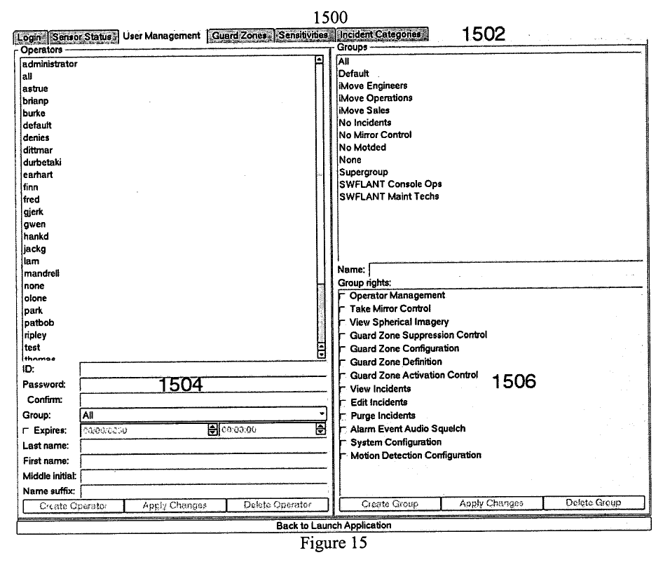

FIG. 15 is a screenshot of an AD 1500, in accordance with one embodiment of the present invention. One purpose of the AD 1500 is to provide an interface for supervisors and administrators of the system 100 to configuration data and operational modes and to provide a means for detailed status information about the system 100. In one embodiment, the AD 1500 includes a tab subscreen 1502 interface that includes, but is not limited to, Login and Logout, Sensor Status, User Management, Guard Zone Definition and operation parameterization control, Motion Detection Sensitivities Definition and operation parameterization control, and site specific Incident categories and operational parameterization controls.

In one embodiment of the AD 1500, the User Management Tab subscreen shows data entry fields 1504 and 1506. In this particular embodiment the data entry fields 1506 represent various authorizations a user of the system 100 may be assigned by a supervisor as defined in the data entry fields 1504.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A surveillance system, comprising:
a sensor subsystem for providing real time spherical image data and surveillance data;
a network operatively coupled to the sensor system for delivering the spherical image data and surveillance data to a management console; and
a management console operatively coupled to the network for receiving the spherical image data and the surveillance data and generating a spherical view display using the spherical image data and a situational awareness management display using the surveillance data.

2. The system of claim 1, wherein the sensor subsystem provides non-image data to the management console via the network and the management console displays the non-image data on the situational awareness management display together with the surveillance data.

3. The system of claim 1, further comprising:
a data repository image database operatively coupled to the network for recording the spherical image data.

4. The system of claim 3, wherein the data repository image database further comprises:
an image recorder for recording the spherical image data; and
an image player for playing back the spherical image data on the spherical view display in response to a user request.

5. The system of claim 3, wherein the data repository supports multiple physical repository types.

6. The system of claim 1, wherein the sensor subsystem further comprises:
an image broadcaster for broadcasting the spherical image data on the network to one or more subscribers.

7. The system of claim 1, wherein the sensor subsystem further comprises:
an image compressor for compressing the spherical image data.

8. The system of claim 1, wherein the surveillance data is motion detection event data.

9. The system of claim 1, wherein the sensor subsystem further comprises:
a motion detection module coupled to the network for generating motion detection event data in response to detecting motion in spherical image data received from the network.

10. The system of claim 9, where the motion detection module detects motion in a selected portion of the spherical image data received from the network.

11. The system of claim 1, wherein the situational awareness management display further comprises:
a sensor system map for displaying the location of one or more sensors in the sensor subsystem.

12. The system of claim 1, wherein the situational awareness display includes user controls for setting a zone in the spherical imagery where the motion detection module will perform motion detection.

13. The system of claim 1, wherein the spherical view display includes user controls for providing a high-resolution image of a selected portion of the spherical view display.

14. The system of claim 2, wherein the non-image data is alarm data generated by an alarm source.

15. The system of claim 7, wherein the management console includes an image decompressor for decompressing the spherical image data compressed in the sensor subsystem and displays the decompressed spherical imagery on the spherical view display.

16. The system of claim 9, wherein the motion detection module detects motion in the spherical image data by comparing a current spherical video frame to a reference spherical video frame and determining differences according to user defined settings.

17. The system of claim 1, wherein the surveillance data is used to track a moving object in the spherical image data.

18. The system of claim 1, wherein metadata is generated in the sensor subsystem and transmitted over the network for use by the management console to build the situational awareness display.

19. The system of claim 1, wherein at least one of the spherical image data and surveillance data is time stamped.

20. The system of claim 9, further comprising:
a mirror control operatively coupled to the motion detection module for controlling a pan/tilt/zoom device in response to motion detection event data generated by the motion detection module.

21. A method of capturing, delivering and displaying spherical image data and motion detection data to a management console, comprising:
capturing real time spherical image data at a sensor subsystem;
monitoring the spherical image data for motion;
responsive to detection of motion, generating motion detection event data;
delivering the spherical image data and motion detection event data to a management console via a network; and
at the management console, generating a spherical view display using the spherical image data.

22. The method of claim 21, further comprising:
generating a situational awareness management display using the motion detection data.

23. The method of claim 21, wherein the spherical image data is broadcast to one or more subscribers on the network.

24. The method of claim 21, further comprising the steps of:
compressing the spherical data at the sensor subsystem; and
decompressing the compressed spherical data at the management console prior to display.

25. The method of claim 21, further comprising:
tracking a moving object in the spherical image data.

26. The method of claim 25, further comprising:
displaying the moving object on the situational awareness map.

27. A management console for a surveillance system, comprising:
a processor for receiving spherical image data and surveillance data from a sensor subsystem via a network;
a spherical sensor display coupled to the processor for displaying spherical image data; and
a situational awareness display coupled to the processor for displaying surveillance data.

28. The management console of claim 27,further comprising:
a user interface for allowing a user to configure the sensor subsystem.

29. A user interface for a surveillance system, comprising:
an image receiver for receiving real time spherical image data and surveillance data;
a display engine for integrating the spherical image data and surveillance data; and
a user interface coupled to the display image for displaying the integrated spherical image data and surveillance data.

30. The user interface of claim 29, further comprising:
a display portion for displaying a sensor system map showing sensor coverage area.

31. The user interface of claim 29, further comprising:
a control portion for controlling the display portion of the user interface.

32. The user interface of claim 29, wherein the sensor system map is a three-dimensional map showing location and orientation of sensors using location and attitude information associated with the sensors.

33. A computer-readable medium having stored thereon instructions which, when executed by a processor in a surveillance system, cause the processor to perform the operations of:
receiving spherical image data and surveillance data from at least one sensor;
integrating the spherical image data and surveillance data; and
displaying the integrated spherical image data and surveillance data on a user interface.

34. The computer-readable medium of claim 33, further comprising:
tracking a moving object in the spherical image data; and
displaying the moving object on the user interface.
